(19) United States
(12) Patent Application Publication
(10) Pub. No.: US 2013/0325860 A1
(43) Pub. Date: Dec. 5, 2013

(54) SYSTEMS AND METHODS FOR AUTOMATICALLY GENERATING A RÉSUMÉ

(71) Applicant: Massively Parallel Technologies, Inc., Boulder, CO (US)

(72) Inventor: Kevin D. Howard, Tempe, AZ (US)

(21) Appl. No.: 13/909,825

(22) Filed: Jun. 4, 2013

Related U.S. Application Data
(60) Provisional application No. 61/655,251, filed on Jun. 4, 2012.
(60) Provisional application No. 61/776,484, filed on Mar. 11, 2013.
(60) Provisional application No. 61/812,182, filed on Apr. 15, 2013.

(51) Int. Cl. G06F 17/27

(52) U.S. Cl. CPC G06F 17/27
USPC 707/736

(57) ABSTRACT

A résumé of a developer working with a parallel processing development environment is, at least in part, automatically generated by the parallel processing development environment based upon information of the developers work experience within the development environment.

### RELATED APPLICATIONS

This application claims the benefit of priority to U.S. Provisional Patent Application No. 61/655,251, filed Jun. 4, 2012, and U.S. Provisional Patent Application No. 61/776,484, filed Mar. 11, 2013, and U.S. Provisional patent Application No. 61/812,182, filed Apr. 15, 2013, each of which are incorporated herein by reference in their entirety. This application further incorporates by reference U.S. Patent Application Publication Number 2012/0036399 A1, titled “System and Method for Automated Software Application Development”, filed Aug. 9, 2010, for enablement purposes and to provide details of the software development environment referenced herein.

### BACKGROUND

Résumés define the education and experience of a developer. Typically a résumé is created and maintained by a developer. For potential employers, knowing that the experience given correctly represents the experience of the software developer is a problem. This problem becomes much worse in a global software application development environment.

Developers frequently list their skills on their résumé. The difficulty is in quickly and easily verifying those skills. There are two separate but related problems concerning software technology training. The first problem concerns the economic value of a technology skill. Prior to developers spending time and money to learn a new skill, it would be useful to know the current economic value of the skill, not its value last year, last month, or even yesterday, but the current value. Additionally, this information would allow prospective technology learners to better focus their training efforts. The second problem is determining how much an organization (i.e. a job solicitor) needs to pay for developers with certain skills.

Additionally, when comparing résumés of two or more software developers, the only information available to the hiring organization pertains to previous employers, length of employment, a description of the work performed, the skill set used, and educational attainment. There is no indication of how well the software developer actually works in relation to other workers.

### SUMMARY OF THE INVENTION

If a developer is in a closed Internet-based software development environment, then it becomes possible to not only transmit and receive résumés, as is very common, but to also have the development environment generate the experience portion of the résumé. Having the development system track the work performed as well as acting as the conduit to transmit and receive those résumés ensures that the correct experience of a developer is always available to a prospective employer.

One aspect herein describes a method for automatically generating a résumé of a developer using a development environment, including retrieving, from a database using a processor of the development environment, information including work completed by the developer, and associated start and end dates of the completed work; and generating, using the processor, a description of developer experience within the development environment based upon the completed work and the associated start and end dates.

In a second aspect, a method for automatically determining the value of a developer skill within a development environment is described, the method including: (i) receiving, from a value requestor, a skills input defining a developer skill to be valued; (ii) determining, using a skill value analyzer of the development environment, a developer fee associated with the developer skill; (iii) determining, using the skill value analyzer of the development environment, a license fee associated with the developer skill; and, (iv) displaying one or more of the license fee and developer fee to the value requestor.

In a third aspect, a method for automatic developer assessment of a developer within a development server is described, the method including: receiving a decomposition diagram of a software design including a plurality of decomposition levels each having at least one process; assigning at least one first developer to each at least one process; determining whether the software design is complete; assigning a score to the at least one first developer for each at least one process; and, determining developer assessment information as compared to at least one second developer.

In another aspect, a system for automatically generating a résumé of a developer using a development environment is described, the system including: a résumé generator, stored within memory as computer readable instructions that when executed by a processor perform the functions of: retrieving, from a database, information including work completed by the developer and associated start and end dates of the completed work, and generating the résumé including a description of developer experience within the development environment based upon the completed work and the associated start and end dates.

### BRIEF DESCRIPTION OF THE FIGURES

FIG. 1 shows one exemplary parallel processing development environment that includes a management server and a server cluster, in an embodiment.

FIG. 2 shows one exemplary high level design process review screen, wherein an administrator for the project reviews the high level design and results of the review are stored within the database of FIG. 1, in an embodiment.

FIG. 3 shows one exemplary test plan entry screen that is stored within the database of FIG. 1, in an embodiment.

FIG. 4 shows one exemplary task assignment screen, in an embodiment.

FIG. 5 shows one exemplary component screen showing the developer requesting a post from the administrator, in an embodiment.

FIG. 6 shows one exemplary post status screen showing the post request accepted by an administrator of the project, in an embodiment.

FIG. 7 shows one exemplary New Kernel Screen illustrating entry of meta-data for a Kernel called TestKernel, in an embodiment.

FIG. 8 shows the résumé of FIG. 1 in further detail, in an embodiment.

FIG. 9 shows one exemplary database procedure for creating the résumé table of the system of FIG. 1.

FIG. 10 shows one exemplary résumé add screen that allows a developer to enter résumé information into a résumé table within the system of FIG. 1.

FIG. 11 shows one exemplary data screen illustrating three rows of the résumé table of system 100 of FIG. 1.

FIG. 12 shows one exemplary parallel processing development 1200 environment for automatic skills tracking, in one embodiment.

FIG. 13 depicts an exemplary résumé with a certified skills list, in one embodiment.

FIG. 14 depicts an exemplary detailed skills list, in one embodiment.

FIG. 15 depicts a developer résumé having a skills list with associated experience amount, in one embodiment.

FIG. 16 depicts a detailed skills list including the skill experience amount, in one embodiment.

FIG. 17 depicts an exemplary parallel processing development environment for automatic job payment determination, in one embodiment.

FIG. 18 depicts an exemplary graph showing cost data related to jobs per month, in one embodiment.

FIG. 19 depicts an exemplary graph showing cost data related to development fees per month, in one embodiment.

FIG. 20 depicts an exemplary graph showing cost data related to license fees per month, in one embodiment.

FIG. 21 depicts an exemplary job value analyzer user interface, in one embodiment.

FIG. 22 depicts an exemplary display of particular job values, in one embodiment.

FIG. 23 depicts an exemplary cost information display that is generated by one or more of skills value analyzer and job value analyzer, of FIG. 17, in one embodiment.

FIG. 24 depicts on exemplary software development environment for automatic developer assessment, in one embodiment.

FIG. 25 depicts an exemplary graphical representation of software design of FIG. 24, in one embodiment.

FIG. 26 depicts an exemplary software design process kernel having a plurality of control flows within a level of FIG. 25.

FIG. 27 depicts an exemplary graphical representation of a finite state machine of a software design, in one embodiment.

FIG. 28 depicts an exemplary software development method for generating a software design within the system of FIG. 24, in one embodiment.

FIG. 29 depicts an exemplary screenshot including a drop down menu for associating a requirement with a process, in one embodiment.

FIG. 30 depicts an exemplary requirements matrix showing associated requirements to each process within a screenshot, in one embodiment.

FIG. 31 depicts an exemplary screenshot of a project metrics data.

FIG. 32 depicts a screenshot of an exemplary popup window for attaching keywords to a process of software design, in one embodiment.

FIG. 33 depicts a screenshot of an exemplary popup window for attaching a description to the process of FIG. 32.

FIG. 34 depicts a screenshot of an exemplary popup window for attaching at least one test procedure to the process of FIG. 32.

FIG. 35 depicts a screenshot of an exemplary popup window including a “generate” button for attaching code to particular processes.

FIG. 36 depicts an exemplary screenshot including an administrator acceptance button.

FIG. 37 depicts an exemplary ranking array for ranking developers over a single project.

FIG. 38 depicts an exemplary screenshot including a developer résumé created within the system of FIG. 1.

FIG. 39 depicts an exemplary screen shot 3900 including a popup window displaying additional assessment information, in one embodiment.

FIG. 40 depicts an exemplary method for automatic developer assessment, in one embodiment.

FIG. 41 depicts an exemplary management server for generating a developer résumé utilizing one or more of the above described concepts, in one embodiment.

### DETAILED DESCRIPTION OF THE EMBODIMENTS

Accessing the Developer Résumé

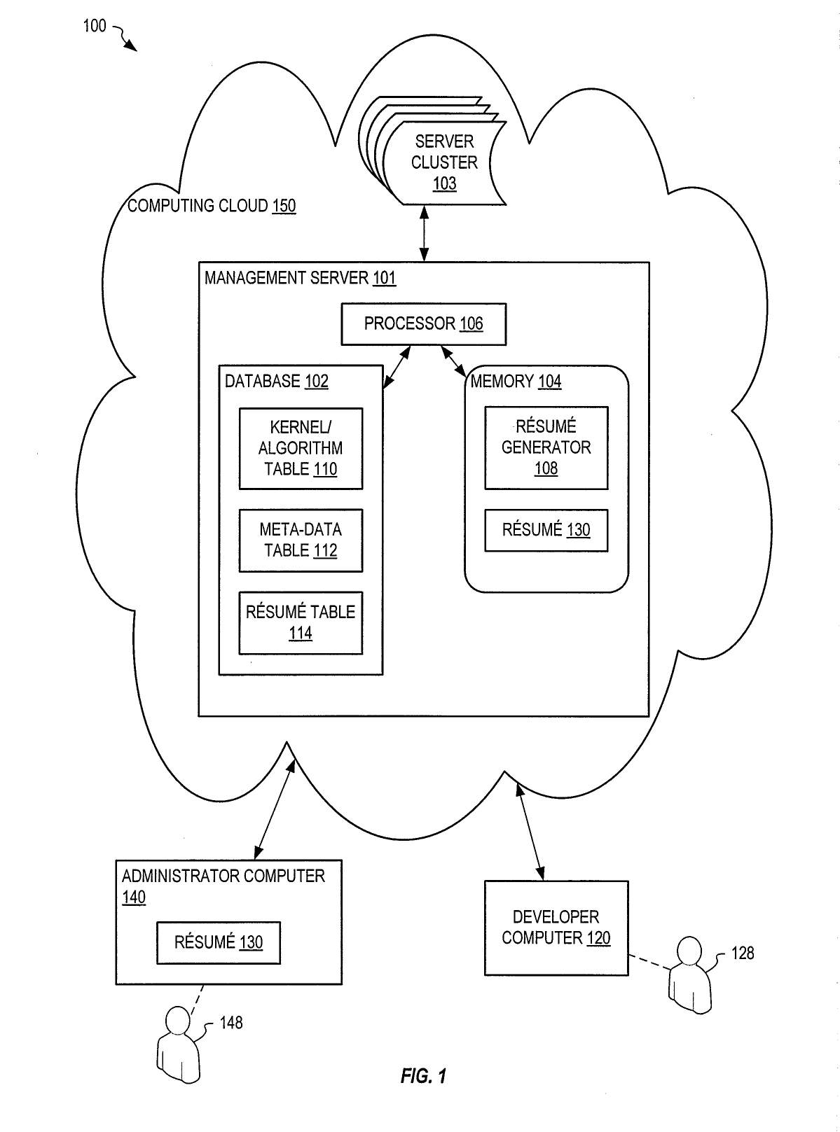

FIG. 1 shows one exemplary parallel processing development environment 100 that includes a management server 101 and a server cluster 103 (management server 101 is similar to system 100 for automating a customer demand to application development, and server cluster 103 is similar to server cluster 107, of U.S. Publication No. 2012/0036399 A1 incorporated herein). Server cluster 103 provides parallel processing capability and may be in the form of a plurality of computing nodes that operate in a manner similar to a Howard Cascade. Management server 101 includes a database 102, a memory 104, and a processor 106. Although shown as a single computer system, management server 101 may include multiple computer systems (e.g., computer servers) that are interconnected (e.g., using a computer network). Where implemented as multiple computer systems, these systems may be co-located and interconnected using a local area network, and/or distributed and interconnected using wide area networks (e.g., the Internet, dedicated networks, and so on). Database 102 is a data network storage device, for example.

Memory 104 may represent one or more of volatile memory (e.g., RAM, DRAM, static memory, and so on) and non-volatile memory (e.g., FLASH, magnetic media, optical media, and so on). Memory 104 is shown storing a résumé generator algorithm 108 that comprises machine readable instructions that when executed by processor 106 process data within database 102 to generate a résumé 130 detailing experience of developer 128 interacting with development environment 100. Exemplary data processed by résumé generator 108 will be discussed in further detail below.

Management server 101 allows an independent developer signup using the “Developer Signup” button on an interactive web page of server 101. Selection of the “Developer Signup” button causes the “Developer Signup” screen to be displayed. Once the developer has signed up then the developer can login by selecting the Developer Login button. Selecting the “Developer Login” button causes the developer login screen to be displayed. Logging in as a developer causes the “Organization Independent Developer” screen to be displayed. Organization Independent Developer Screen is a screen that is displayed on developer computer 120, for example. On the bottom middle of the Organization Independent Developer screen is a “Résumé” button. Résumé generator algorithm 108 processes information within kernel/algorithm table 110, meta-data table 112 and résumé table 114 of database 102 and generates résumé 130 to contain experience by developer 128 within development environment 100.

Automatic Résumé Components

FIG. 8 shows résumé 130 of FIG. 1 in further detail. Résumé 130 has two components; a static component 802 and a dynamic component 804. Selecting the Résumé button in on the Organization Independent Developer screen causes the Résumé screen to be displayed. The top part (e.g., static component 802) of the résumé is created by the developer and is called the accessible screen. Information for static component 802 is stored within résumé table 114, for example. There are three buttons on the accessible résumé screen: Add 806, Change 808, and Delete 810. Selection of the Add button 806 causes an Add Screen to be displayed. The Add Résumé screen allows the developer to add their name, educational background, total years of experience, and a keyword list of their technical highlights. Once all fields are completed selecting the submit button (green leaf) creates a new entry in résumé table 114 if one does not already exist. If an entry already exists within résumé table 114 then the Add button 806 is grayed out. If an entry does not exist within résumé table 114 then the change 808 and delete 810 buttons are grayed out. If an entry does exist within résumé table 114, then the change 808 and delete 810 buttons are selectable.

Selecting the Change 808 button causes a Change Résumé Screen to appear. Any field within résumé 130 can be changed. Selection of the submit button causes the changes to be saved. The delete button 810 does not generate a popup screen; it simply deletes the résumé 130 from database 102. When adding, changing, or deleting is complete an “Are you sure? Yes No” popup is displayed. If yes is selected then the change is committed. If no is selected then the change is not committed.

The bottom part (e.g., dynamic component 804) of the résumé screen is generated automatically by the Management server 101. The information for generating the bottom part of the screen comes from database 102 and is provided to database 102 from one or more of a Projects and a Components Screen. For example, dynamic component 804 may display information related to a particular project task and/or component task. Dynamic component 804 may include only a single task (either project or component) at one time, or it may display more than one task at the same time. The description of the project task and/or component task is defined in the work type box 812.

Project Tasks

The following are exemplary project tasks: Requirements Chapters (purpose, market, product overview, requirements, constraints, and workflows), High Level Design (processes, terminators, and data stores), and Test procedures (listed by process). Each project task may be monitored to determine whether to be included on the developer résumé. The starting and ending dates for project level work tasks come from the date when edit privileges are given to the developer 128. The date when developer 128 is given edit privileges for a particular project work type is saved in database 102. The ending date for that given work type is stored within database 102 when an administrator reviews and accepts the work.

In one embodiment, all project work types are reviewed in a similar way. For example, each process element within a high level design has a description, stored within database 102, which is used for the type description within résumé 130.

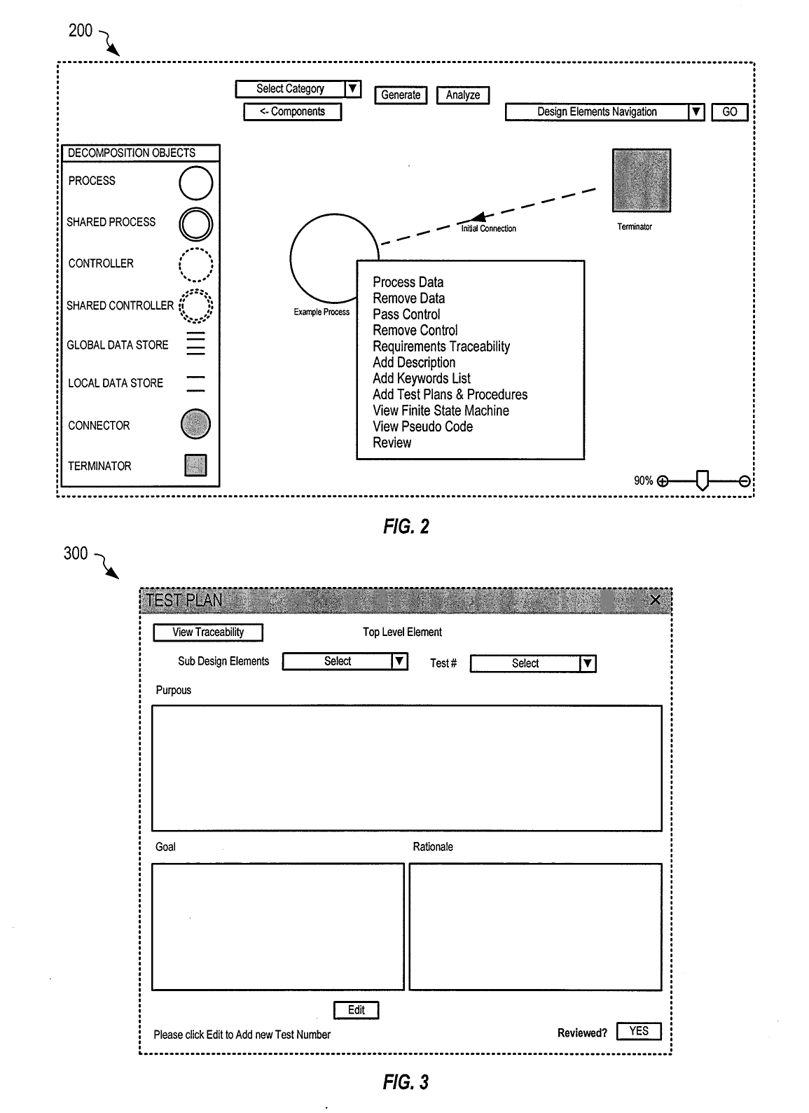

FIG. 2 shows one exemplary high level design process review screen 200, wherein an administrator for the project reviews the high level design and results of the review are stored within database 102. FIG. 3 shows one exemplary test plan entry screen 300 that is also stored within database 102. Test plans may be generated for each project within development environment 100.

Exemplary descriptions for various project types are given in the table below:

| # | Type | Description |
|---|---|---|
| 1 | Project - Requirement: Purpose | I wrote the purpose chapter of |
| | | the requirements document |
| 2 | Project - Requirement: Market | I wrote the market chapter of the |
| | | requirements document |
| 3 | Project - Requirement: Product | I wrote the product overview |
| | Overview | chapter of the requirements |
| | | document |
| 4 | Project - Requirement: | I wrote the requirements chapter |
| | Requirements | of the requirements document |
| 5 | Project - Requirement: Constraints | I set the constraints within of the |
| | | requirements document |
| 6 | Project - Requirement: Work Flow | I wrote the workflow chapter of |
| | | the requirements document |
| 7 | Project - HLD: xxxxxxxxxxxxxxx | Associated Description |
| 8 | Project - Test Plans: test # | Purpose |

Component Tasks

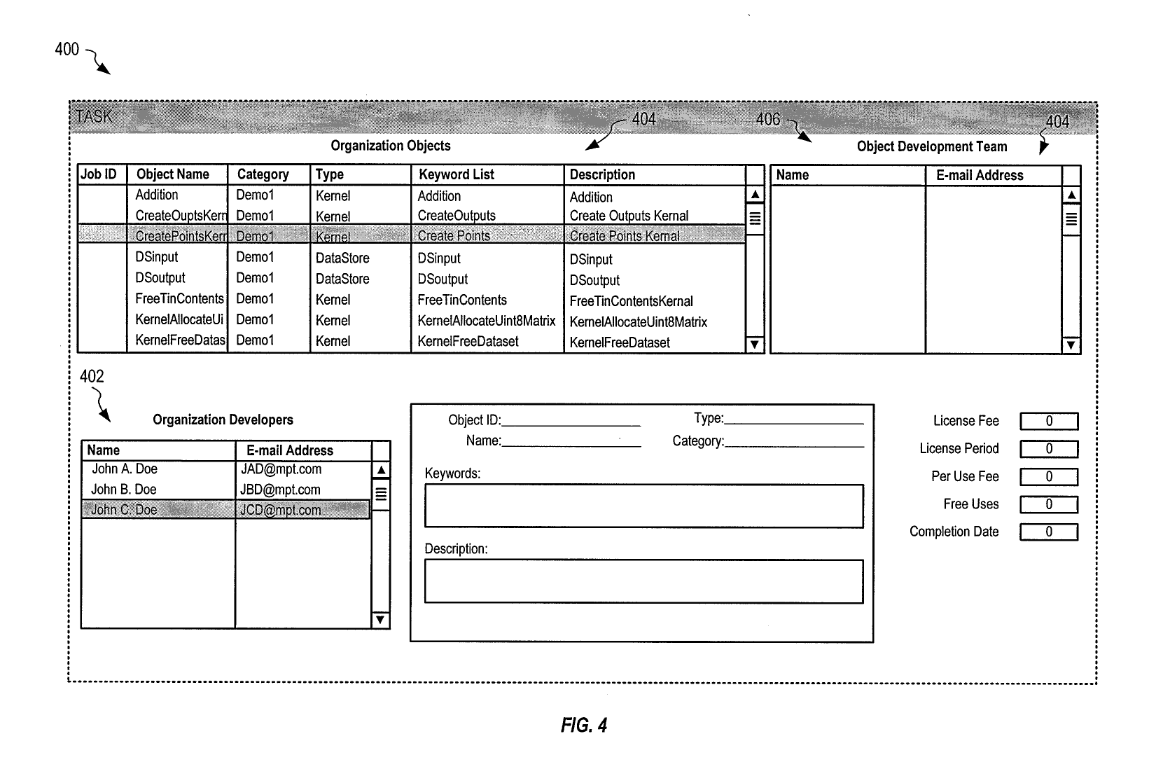

FIG. 4 shows one exemplary task assignment screen 400. In one embodiment, there are three task types in components: Kernels, Algorithms, and Data Stores. The component task starting dates on the résumé 130 are determined from database 102. Database 102 stores the date that the task is assigned, which occurs on the task assignment screen when the administrator selects a developer from the “Organization Developers” portion 402 of screen 400 and then selects the component task from the “Organization Objects” portion 404 of screen 400, by clicking within the row of an object. All developers selected for the current object are shown in the “Object Development Team” portion 406 of screen 400. The objects details are shown on the rest of screen 400.

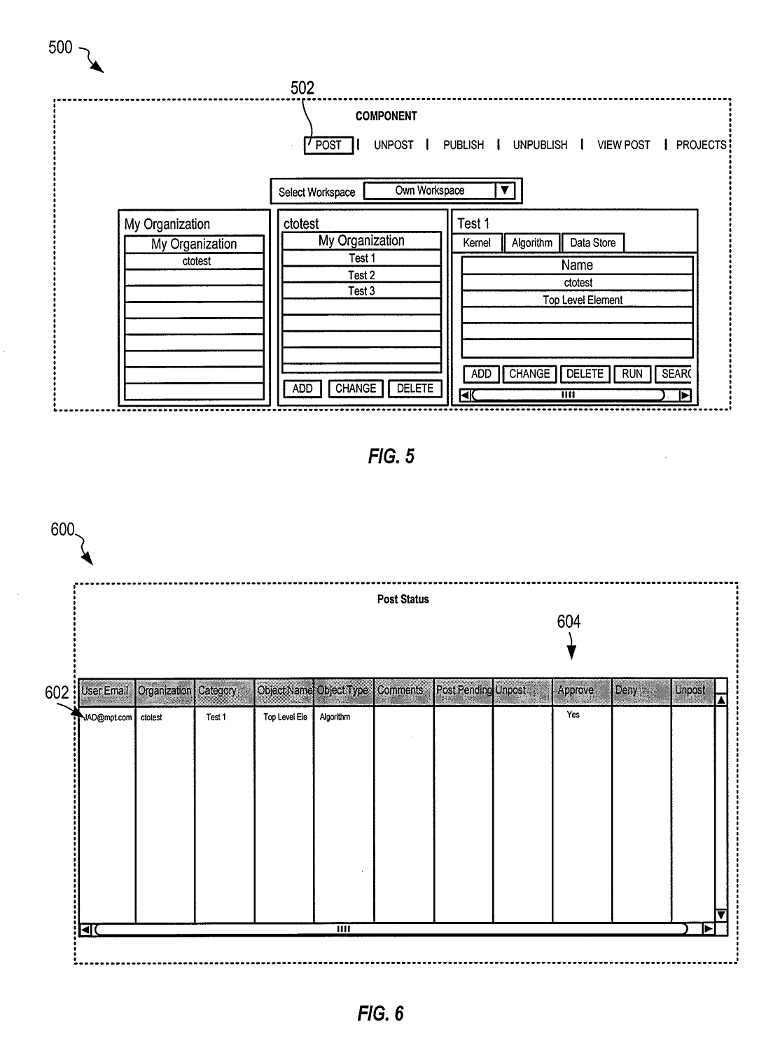

FIG. 5 shows one exemplary component screen 500 showing developer 128 requesting a post from the administrator. The component task ending date used for résumé 130 is defined within database 102 when the administrator accepts a “Post” of that object. Posting is performed by the developer 128, who has a particular task assigned to them, first selecting “completed assigned task” within their own workspace (e.g., on the Component Screen 500) and then selecting the Post button 502.

FIG. 6 shows one exemplary post status screen 600 showing the post request accepted by an administrator of the project. Once the Post request has been sent, the administrator of the project accepts the post from the Post Status screen by selecting “Yes” for the selected task 602 from the Approve column 604.

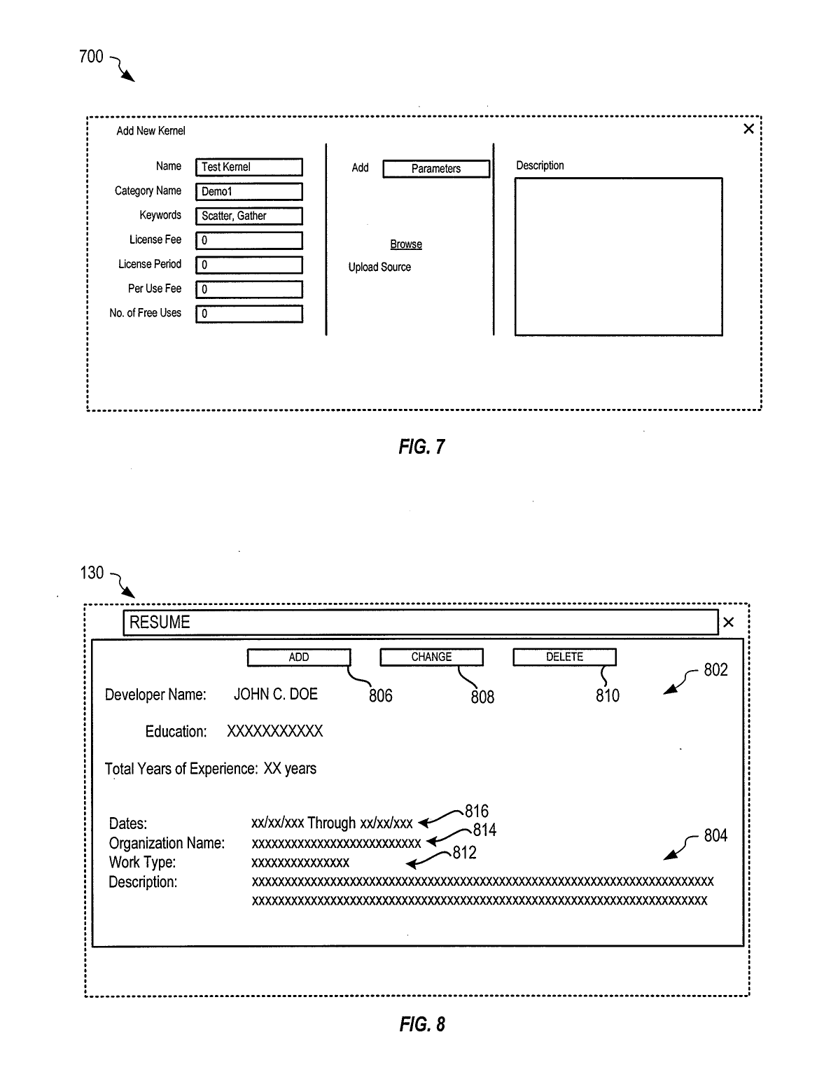

As included within résumé 130, the description for a component task is determined from database 102 that includes meta-data for each kernel, algorithm, and data. FIG. 7 shows one exemplary New Kernel Screen 700 illustrating entry of meta-data for a Kernel called TestKernel.

Automatic Job Task Update

The bottom portion (e.g., dynamic component 804) of the résumé 130 is generated automatically by résumé generator algorithm 108 within management server 101. The dates 816 are generated, as discussed above, for each work type. As shown in FIG. 8, the organization 814 that the work type is attached to is included within résumé 130. The work type 812 is associated with each task. The description is obtained as discussed above.

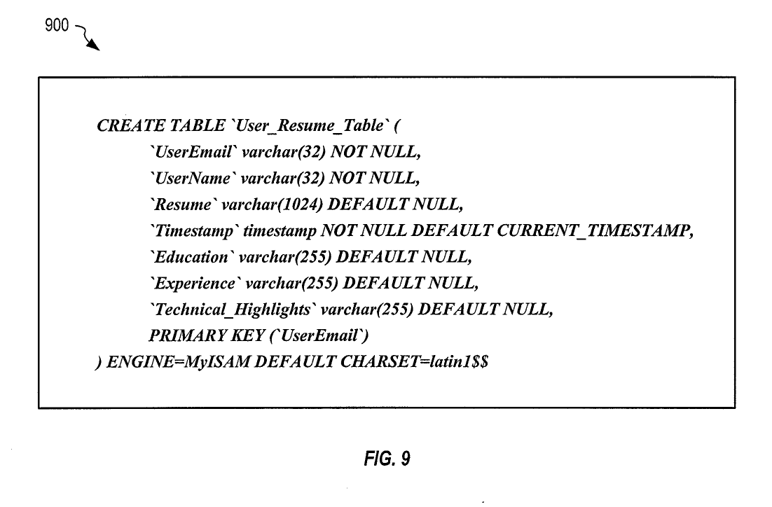

FIG. 9 shows one exemplary database procedure 900 for creating résumé table 114 within database 102 of system 100, FIG. 1. Résumé table 114 is for example created upon initialization of system 100.

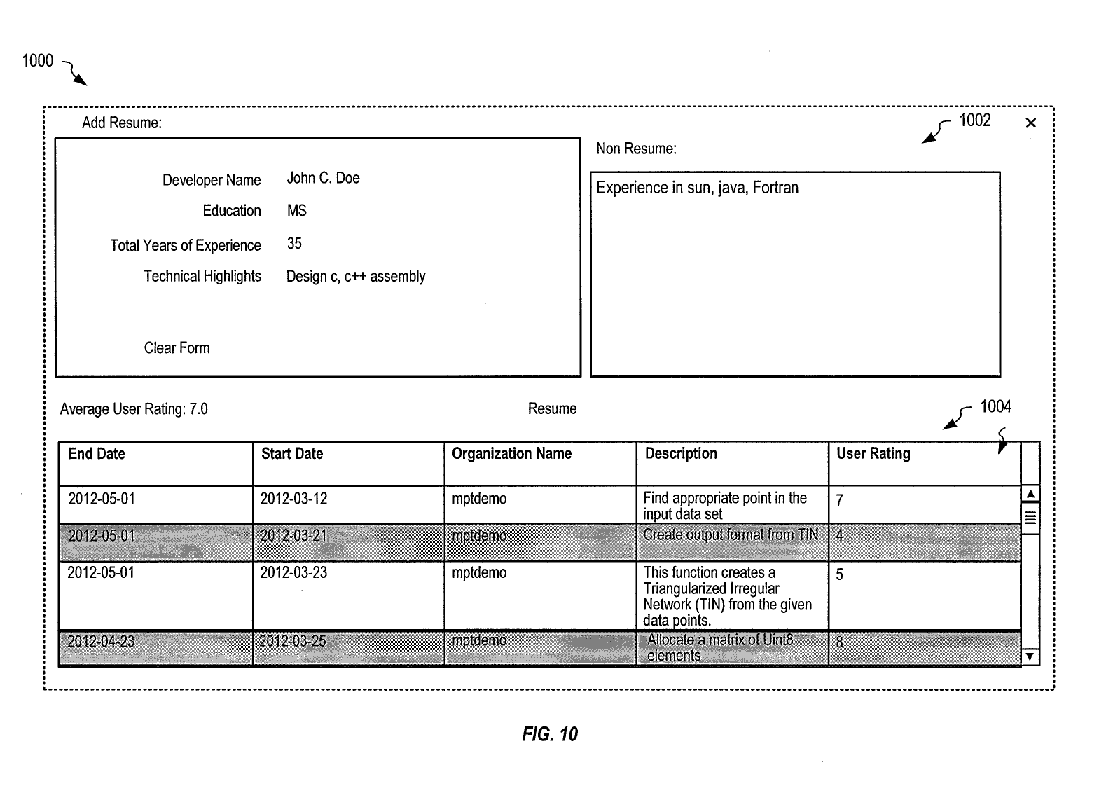

FIG. 10 shows one exemplary résumé add screen 1000 that allows developer 128 to enter résumé information into résumé table 114 of database 102 within system 100, FIG. 1. A top portion 1002 of screen 1000 allows developer 128 to enter experience gained external to system 100, and a lower portion of screen 1000 lists experience gained within system 100. Lower portion 1004 is not editable by developer 128 and is generated automatically by system 100, as described above.

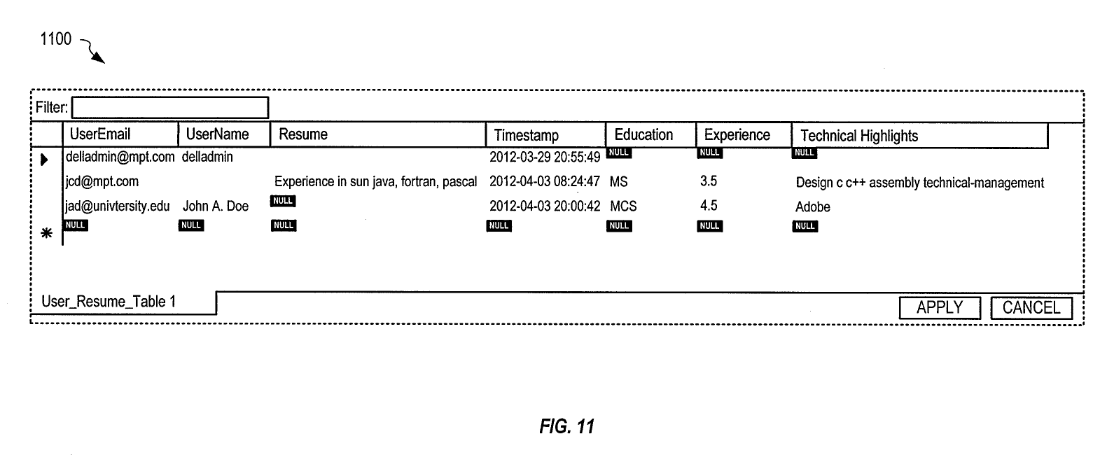

FIG. 11 shows one exemplary data screen 1100 illustrating three rows of résumé table 114 as stored within database 102 of system 100, FIG. 1. Specifically, the second row displayed within screen 1100 illustrates the exemplary information entered by developer 128 within screen 1000 of FIG. 10.

Skill Acquisition Certification:

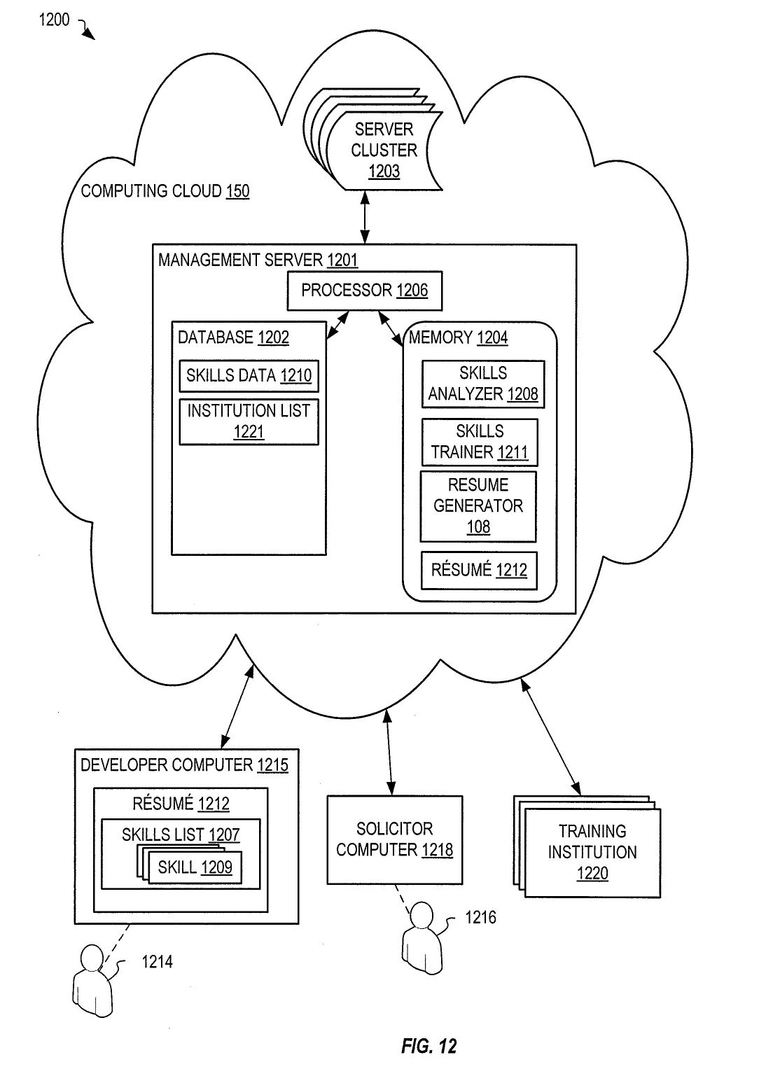

Résumé generator 108 may further generate résumé 1212, of FIG. 12 including particular skills that a developer has acquired.

FIG. 12 shows one exemplary parallel processing development 1200 environment for automatic skills tracking, in one embodiment. Development environment 1200 includes, inter alia, management server 1201 and a server cluster 1203. Server cluster 1203 may be used separately for serial processing or together for parallel processing. Management server 1201 includes a database 1202, a memory 1204 and a processor 106. Management server 1201, database 1202, server cluster 1203, memory 1204, and processor 1206 may be similar to each of management server 101, database 102, server cluster 103, memory 104, and processor 106, respectively, however incorporating the below additional/different elements (and additionally are similar to elements within US Publication No. 2012/0036399, e.g. server cluster 1203 provides parallel processing capability for executing customer applications consistent with a Howard Cascade).

Memory 1204 is shown storing a skills analyzer algorithm 1208 that comprises machine readable instructions that when executed by processor 1206 process skills data 1210 within database 1202 to generate a résumé 1212 detailing experience of developer 1214. Résumé 1212 may be similar to résumé 130 of FIG. 1 incorporating automatic skill acquisition certification as described below. Experience of the developer includes a skills list 1207 that defines at least one skill 1209 that the developer 114 has acquired from experience (e.g. computer programming skills such as c, c++, java, ruby, HTML, etc. and/or management skills, and/or other technical training acquired). Skills list 1207 is not limited in scope to the above list. Each developer 1214 has an associated skills list 1207. Skills data 1210 is for example a compilation of developer's 1214 and their associated skills lists 1207.

Skills analyzer 1208 may function in a plurality of manners. In one embodiment, skills analyzer 1208 processes skills data 1210 to generate a plurality of résumés 1212 associated with a plurality of developers 1214. Accordingly, solicitor 1216 may query skills analyzer 1208 to search for a specific developer 1214 having a particular skill in the developer's 1214 skill list 1207. Solicitor 1216 may execute a query using solicitor computer 1218 that is communicatively coupled to management server 1201 through computing cloud 150. Referring back to FIGS. 1-11, skills analyzer 1208 may further incorporate information from one or more of meta-data table 112, kernel/algorithm table 110, and résumé table 114 as previously discussed to generate one or more résumés 1212.

In another embodiment, skills analyzer 1208 operates to certify each skill 1209 in the developer's skills list 1207. Certification may occur for example based upon an institution 1220 with trusted status within the environment 1200. For example, database includes an institution list 1221. Accordingly, each skill 1209 that developer 1214 acquires from a trusted training institution 1220 will be automatically certified by skills analyzer 1208 by comparing the training institution 1220 to institution list 1221.

In another embodiment, skills analyzer 1208 operates to certify each skill 1209 through the use of skills trainer algorithm 1210. Skills trainer algorithm 1211 is for example machine readable instructions associated with management server 1201 that when executed by processor 1206 complete a training program. Developer 1214 may access skills trainer 1211 through developer computer 1215 to receive training on a particular skill 1209. Once the training program is completed by developer 1214, and the developer 1214 has completed the training program with a pass rate above a predetermined threshold, skills trainer 1211 may automatically update one or more of skills list 1208 and skills data 1210. Further, where a skill 1209 is acquired using skills trainer 1211, skills analyzer 1208 may automatically certify that particular skill within skills data 1210. Additionally, skills analyzer 1208 may automatically update résumé 1212 with the certified skill 1209.

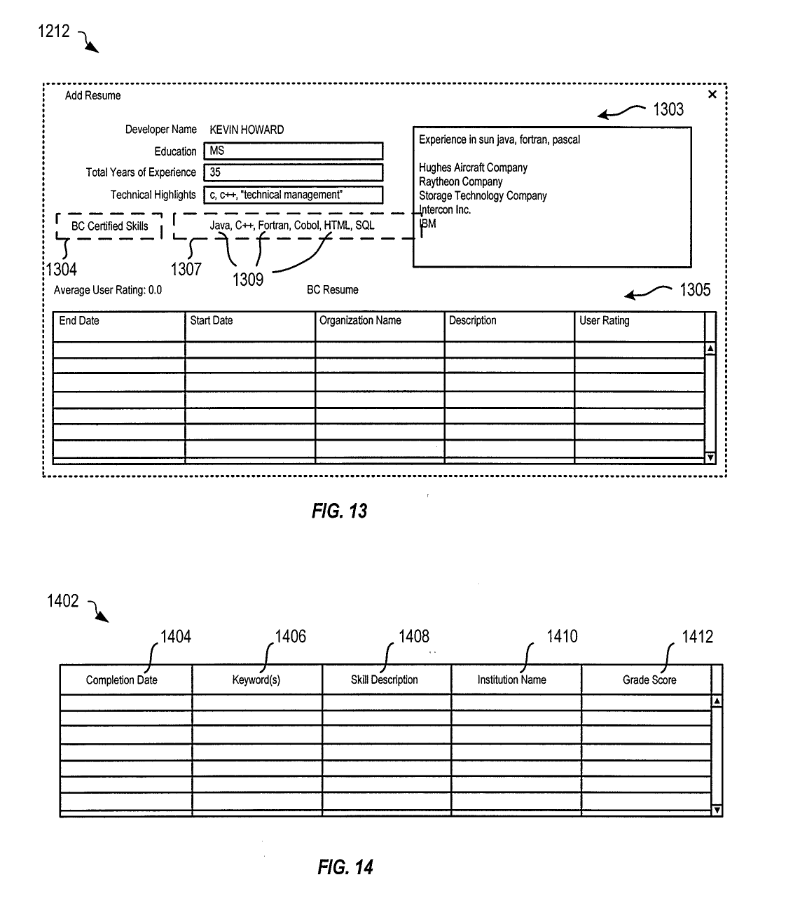

FIG. 13 depicts an exemplary résumé 1212 with a certified skills list 1307, in one embodiment. FIG. 14 depicts an exemplary detailed skills list, in one embodiment. FIGS. 12-14 are best viewed together with the below description. As illustrated, résumé 1212 includes certified skills list 1307. Each skill 1309 has been automatically certified by skills analyzer 1208, using either skills trainer 1210, or comparing to a trusted institution 1220 as discussed above. Although not shown, résumé 1212 may additionally have an uncertified skills list.

Skills analyzer 1208 may further operate in conjunction with résumé 1212 such that upon receiving input from either developer 1214 or solicitor 1216, skills analyzer may display solely skills list 1207. For example, résumé 1212 includes a static portion 1203 similar to static portion 802 however it further includes skills defined by the developer.

Résumé 1212 may include a dynamic portion 1305 similar to dynamic portion 804 however further including skills information button 1304 that causes skills analyzer 1208 to generate skills information as illustrated in FIG. 14. For example, either developer 1214 or solicitor 1216 selects skills button 1304. In response to receiving selection of button 1304, skills analyzer 1208 may display detailed skills list 1402 as illustrated in FIG. 14. “Completion date” 1404 is the date the skill was acquired. “Skill keyword(s)” 1406 is the certified skill itself. “Skill description” 1408 is a text description of the acquired skill. “Institution Name” 1410 is the institution where the skill was acquired. “Grade score” 1412 is an indication of how well the skill was learned, typically a number from 1.0 through 4.0, with 4.0 the best possible score. Information 1404-1412 may be stored within skills data 1210 in database 1202. Furthermore meta-data 112, of FIG. 1, may be updated with information 1404-1412 in one embodiment. It will be appreciated in the art that more or fewer of categories 1404-1412 may be incorporated without departing from the scope herein.

### Skill Experience Tracking:

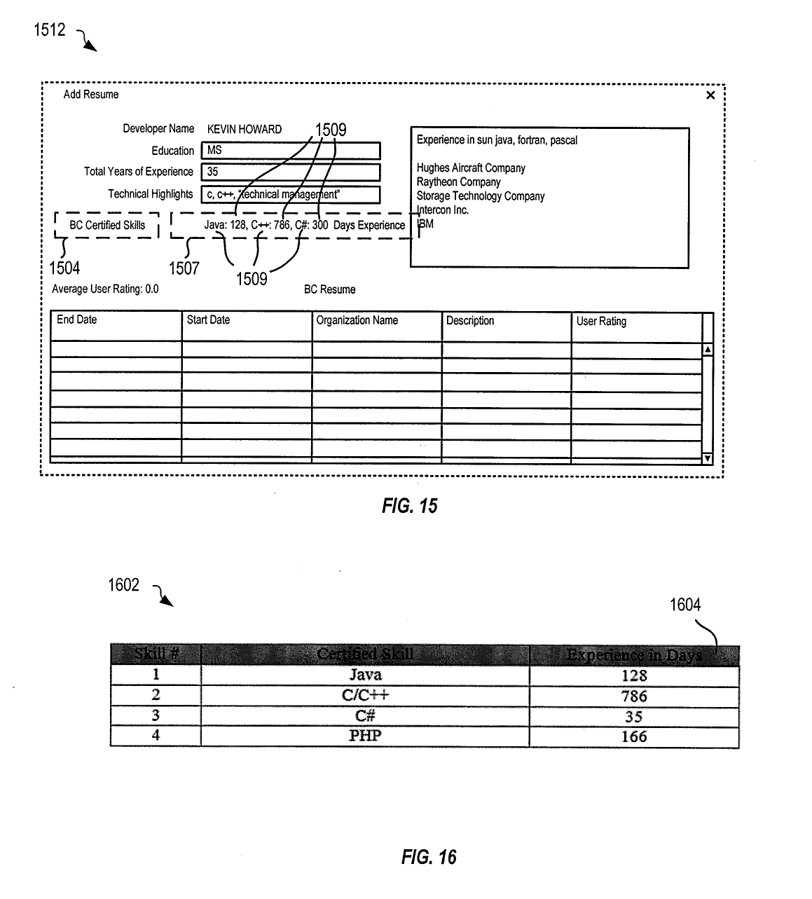

FIG. 15 depicts a developer résumé 1512 having a skills list with associated experience amount, in one embodiment. FIG. 16 depicts a detailed skills list 1602 including the skill experience amount, in one embodiment. Résumé 1512 includes a skills list 1507 including at least one skill 1509 and at least one skill experience amount 1511 associated with each skill. Parallel processing development environment 1200 is shown having developers 1214 and job solicitors 1216. Job solicitors 1216 may interact with developers 1214 such that a developer uses a skill (i.e. skill 1209) to generate a “job”. An important attribute to know from a résumé is how much experience a developer (e.g. developer 1214) has with a particular skill (e.g. skill 1209). This is accomplished by using the “Skills List” found on the developer's résumé screen to understand which skills are used in a job. Where a developer 1214 uses a skill 1209 to complete a job, a developer uses that skill for a certain amount of time (i.e. in days, hours, minutes, and/or years). This amount of time may be defined by a start date and an end date (each of which is stored in skills data 1210 for example). Along with certifying skills, as discussed above, skills analyzer 1208 may combine the skills list 1208 with starting and ending dates to display the number of days experience a developer 1214 has for a given skill 1209. This allows the system to provide two pieces of information to the developers résumé: the actual used skills and the experience level for each skill.

Accordingly, as illustrated in FIG. 15, where button 1504 is pressed, skills analyzer 1208 may display a detailed skills list 1602 including the experience amount 1604. It will be appreciated that detailed skills list may include more or less information than illustrated in FIG. 16. Information in detailed skills list 1602 may additionally be stored in one or more of tables 110-114 within database 102 of FIG. 1.

### Job Payment Determination:

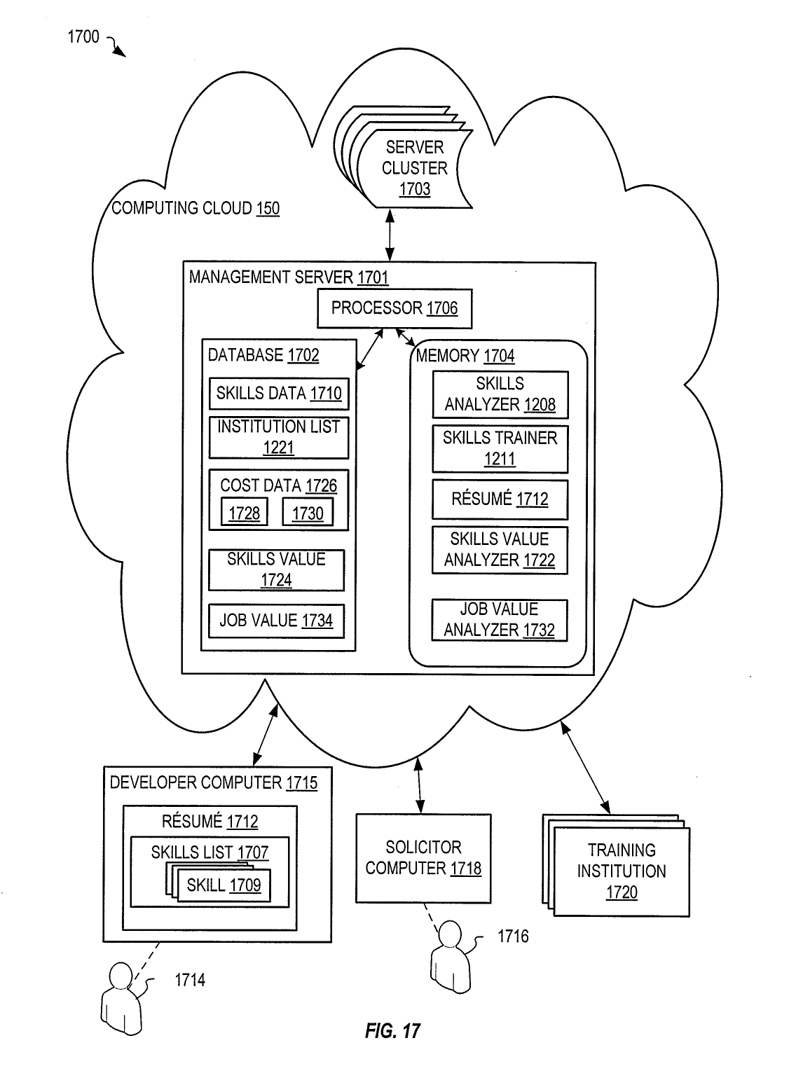

FIG. 17 depicts an exemplary parallel processing development environment 1700 for automatic job payment determination, in one embodiment. Software development environment 1700 includes, inter alia, management server 1701 and a server cluster 1703. Management server 1701 includes a database 1702, a memory 1704 and a processor 1706. Development environment 1700 is similar to development environment 1200 however it further includes one or more of a skill value analyzer 1722 and a job value analyzer 1732, as will be discussed below.

Skill value analyzer 1722 may be stored in memory 1704 and comprise machine readable instructions that when executed by processor 1706 processes cost data 1726 within database 1702 to generate a skill value 1724. Skills value analyzer 1722 utilizes the concept that when a job is completed by a developer 1714 for a job solicitor 1716, three types of payment are allowed for the work solicited: the development fee 1728—a onetime fee paid upon completion of the job, the license fee 1730—the amount paid to the developers every time the code or design that is defined for this job is licensed, or both the development and license fees. The development fee 1728 is calculated as follows:

$$Development Fee : \\ D = \frac{{F}_{d}}{N} ; \qquad Equation 1$$

where F_{d} is the total development fee for the job and N is the total number of developers solicited for the job.

The license fee 1730 for each developer used for the current job is calculated as follows:

$$L = \frac{{PF}_{l}}{N} ; \qquad Equation 2$$

where Fₗ is the total license fee; P is the percentage of the total license fee given to all developers; and N is the total number of developers solicited for the job.

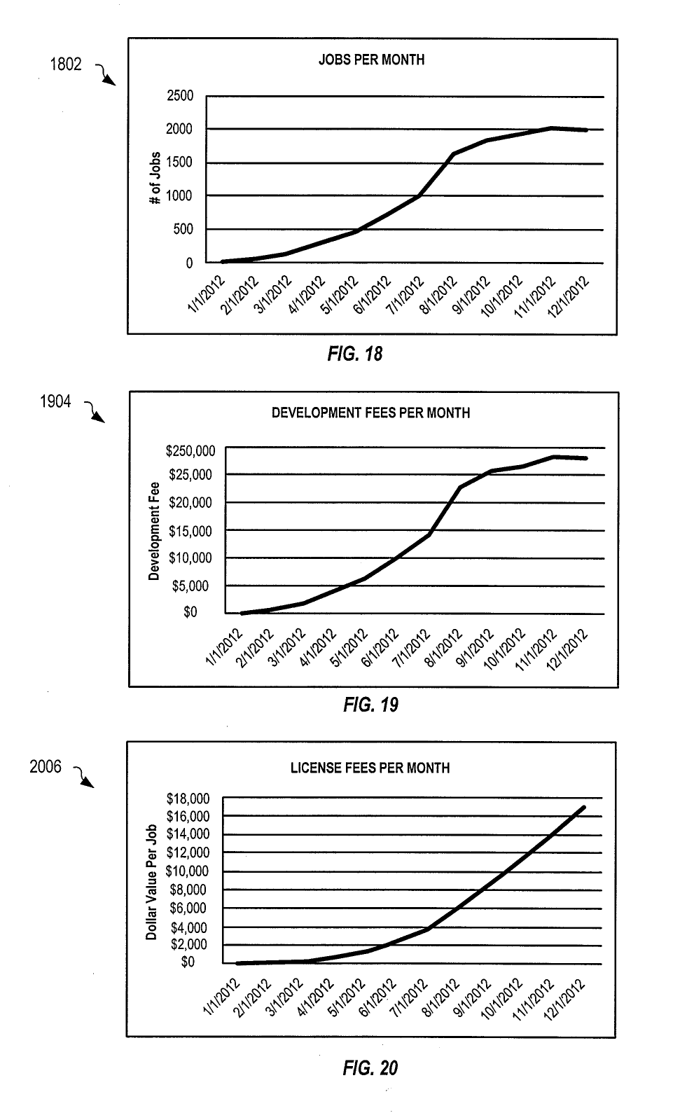

Each skill 1709 may be located by skills value analyzer 1722 using a keyword match. Each skill 607 is for example defined by either a single keyword or several quoted, space-separated keywords. Skill value analyzer 1722 may search skills data 1710 to determine what skills 1709 each particular developer 1714 has. Accordingly, the cost data 1726 may be updated when a particular developer 1714 completes a job. For example, each job contains a mixture of the skills required and the amount paid per developer, as discussed above. Accordingly, the cost data 1726 is updated by skills value analyzer 1722 using equations 1 and 2 above based upon the skills the developer used to complete the job. FIG. 18 depicts an exemplary graph 1802 showing cost data related to jobs per month, in one embodiment. FIG. 19 depicts an exemplary graph 1904 showing cost data related to development fees per month, in one embodiment. FIG. 20 depicts an exemplary graph 2006 showing cost data related to license fees per month, in one embodiment.

In one embodiment, skills value analyzer 1722 receives one or more skills input. Skills input may be received by evaluating a developer's 1714 résumé 1712. For example, skills value analyzer 1722 automatically values each skill 1309 located within certified skills list 1307. Alternatively, skills input may be received by skills value analyzer 1722 by a developer 1714 or job solicitor 1716 inserting one or more skills 1707 into a skill insert box (for example using the concepts discussed with reference to FIGS. 1-11). Skills value analyzer 1722 then utilizes the developer fee and license fee to determine a skill value 1724. In one embodiment, skill value 1724 may be displayed to a value requestor (e.g. the developer 1214 requesting the skill value and/or the solicitor 1216 requesting the skill value). In another embodiment, skill value 1724 may be listed on developer résumé 1712.

Job value analyzer 1732 may be stored in memory 1704 and comprise machine readable instructions that when executed by processor 1706 processes cost data 1726 within database 1702 to generate a job value 1734. In one embodiment, job value analyzer 1734 operates to generate job value 34 defined by the highest paying job for a developer's particular skills.

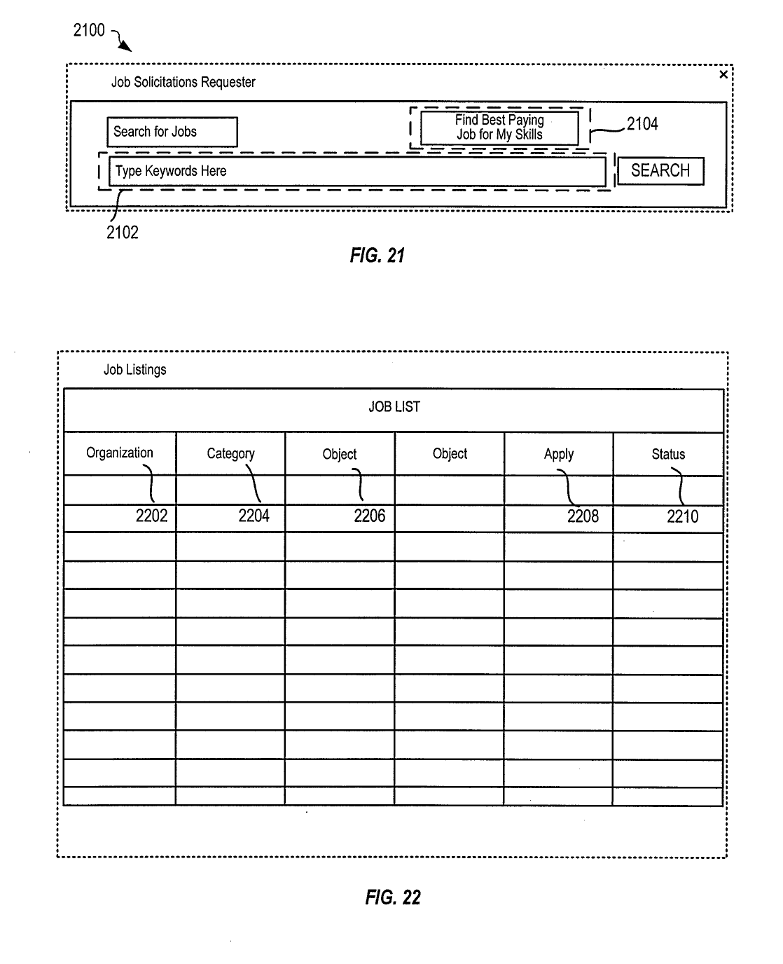

FIG. 21 depicts an exemplary job value analyzer 1734 user interface 2100. In one embodiment, a developer 1714 inserts his/her particular skills within skills search box 2102. In an alternate embodiment, developer 1714 can click an auto skill search button 2104. If the auto skill search button 1704 is selected, job value analyzer 1734 automatically obtains the skill list from the developer's résumé. Job value analyzer 1734 then analyzes jobs that correspond to the received skills and outputs a list of the highest paying jobs. FIG. 22 depicts an exemplary display of particular job values 1734, in one embodiment. Job values 1734 may include the organization name 2202, the category 2204, the objective of the job 2206, an auto apply option 2208 and the status of the job 2210.

Hiring organizations and workers all have the need to know how much a given skill is worth or how much a job will cost. Job value analyzer 1732 and skill value analyzer 1722 utilize the following information to determine the job value 1734 and skill value 1724, respectively. The value of a given skill or group of skills is determined by the development and license fees paid for the skill divided by the estimated completion time.

$$Average Developer Fee for Jobs with Skill List “ s ” : \\ {D}_{s} = \frac{{\sum }_{i = 1}^{n} {D}_{s , i}}{{n}_{s}} ; \qquad Equation 3$$

where Dₛ is the average developer fee paid for some skill (or group of skills) “s”, D_{s,i} is the developer fee paid for some skill (or group of skills) “s” for some job “i”, and nₛ is the number of jobs requiring skill (or group of skills) “s”.

$$Average License Fee for Jobs with Skill List “ s ” : \\ {L}_{s} = \frac{{\sum }_{i = 1}^{n} {L}_{s , i}}{{n}_{s}} ; \qquad Equation 4$$

where Lₛ is the average license fee paid for some skill (or group of skills) “s”, L_{s,i} is the license fee paid for some skill (or group of skills) “s” for some job “i”, and nₛ is the number of jobs requiring skill (or group of skills) “s”.

$$Average Estimated Completion Time for Jobs with Skill List “ s ” : \\ {T}_{s} = \frac{{\sum }_{i = 1}^{n} {T}_{s , i}}{{n}_{s}} ; \qquad Equation 5$$

where Tₛ is the average estimated completion time used to complete a job containing skill (or group of skills) “s”, T_{s,i} is the estimated time to complete job “i” containing skill (or group of skills) “s”; and nₛ is the number of jobs requiring skill (or group of skills) “s”.

$$Average Number of Developers for Jobs with Skill List “ s ” : \\ {C}_{s} = \frac{{\sum }_{i = 1}^{n} {C}_{s , i}}{{n}_{s}} ; \qquad Equation 6$$

where Cₛ is the average developer count used to complete a job containing skill (or group of skills) “s”, C_{s,i} is the number of developers needed to complete job “i” containing skill (or group of skills) “s”; and nₛ is the number of jobs requiring skill (or group of skills) “s”.

$$Average Number of Administrators for Jobs with Skill List “ s ” : \\ {A}_{s} = \frac{{\sum }_{i = 1}^{n} {A}_{s , i}}{{n}_{s}} ; \qquad Equation 7$$

where Aₛ is the average administrator count used to complete a job containing skill (or group of skills) “s”, A_{s,i} is the administrator fee to complete job “i” containing skill (or group of skills) “s”; and nₛ is the number of jobs requiring skill (or group of skills) “s”.

The information generated by either job value analyzer 1732 or skills value analyzer 1722 is then stored in cost data 1726 within database 1702. This information may additionally be added to developer résumé in association with the skill list.

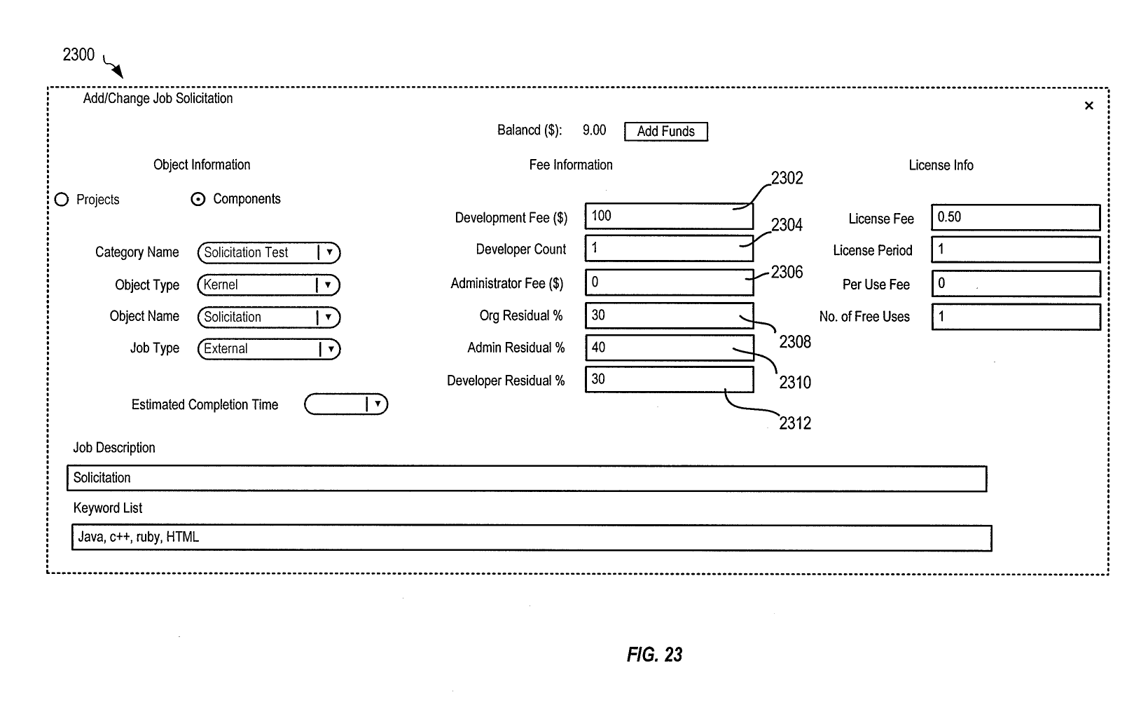

FIG. 23 depicts a cost information display 2300 that is generated by one or more of skills value analyzer 1722 and job value analyzer 1732. Cost information display 2300 may be displayed to either developer 1714 or solicitor 1716. Cost information display 2300 displays one or more of the development fee 2302, the developer count 2304, the administrator fee 2306, the organization residual percentage 2308, the administrator residual percentage 2310, and the developer residual percentage 2312. The residual values are the values obtained by multiplying the license fee by either of the following: the Organization residual percentage, the administration residual percentage or the developer residual percentage depending on who receives the value.

Automatic Developer Assessment

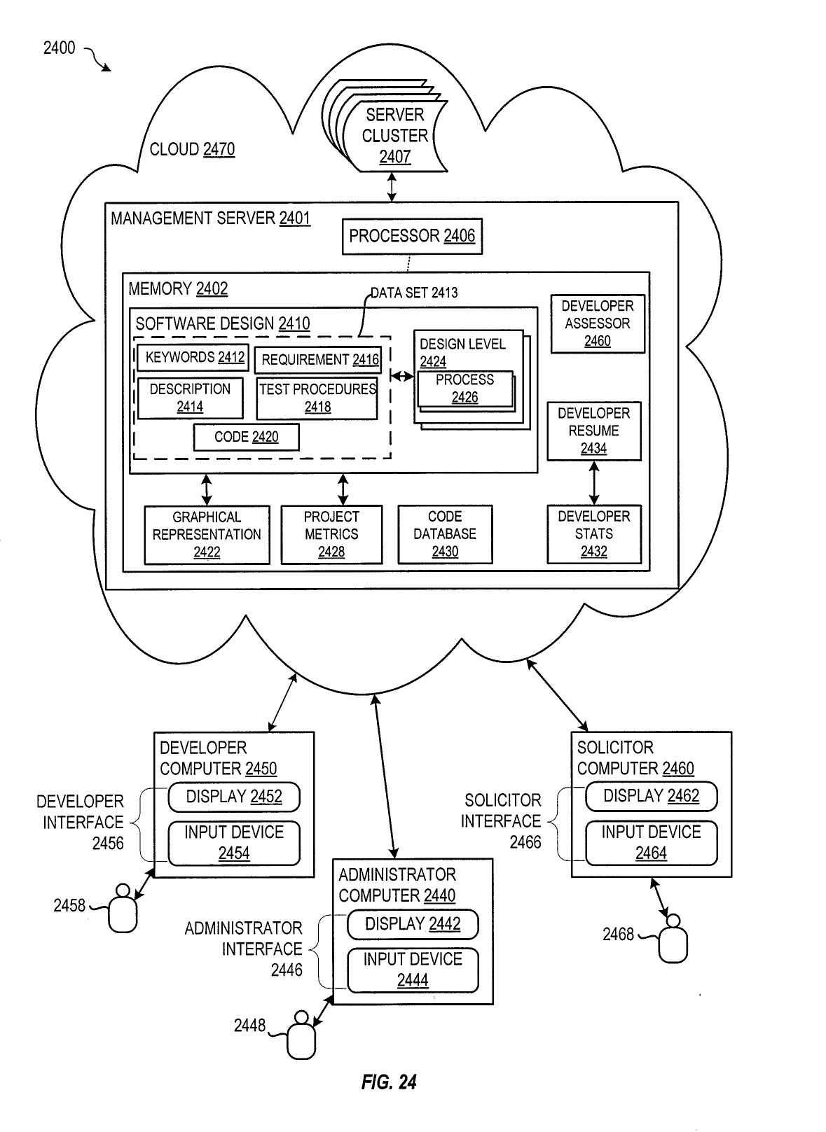

FIG. 24 depicts on exemplary software development environment 2400 for automatic developer assessment, in one embodiment. System 2400 includes a management server 2401 that is located within cloud 2470 (e.g. a computer network accessible via the Internet). Server cluster 2407 is for example a plurality of processing nodes configured to operate as a Howard Cascade. Management server 2401 is a computer with at least one processor 2406 and a memory 2402 that stores a software design 2410. Software design 2410 includes data set 2413 that includes at least one keyword 2412, at least one description 2414, at least one requirement 2416, at least one test procedure 2418 and at least one code 2420 in association with each process 2426 within each decomposition level 2424 of software design 2410 and stored within memory 2402. It is appreciated that software design 2410 may include more or fewer elements associated with software design and stored within memory than illustrated in FIG. 24 without departing from the scope herein.

Keywords 2412 function as metadata about each process. For example, each keyword 2412 is used within management server 2401 to search for particular process code that performs a certain function. Description 2414 is a description of how the process functions. For example, the description includes an overview of the inputs and outputs for a particular process and how the process affects the data. Requirement 2416 defines the specific requirements that the process must accomplish. Requirements 2416 may be allocated by one or more of an administrator 2448, developer 2458, and solicitor 2468. Test procedures 2418 define procedures to verify that a particular process functions correctly within the software design. Code 2420 defines the code associated with the particular process. Each of keywords 2412, description 2414, requirement 2416, test procedures 2418, and code 2420 may be allocated on a micro-level (i.e. for a particular process), on a macro-level (i.e. for the entire software design), or a combination thereof.

Memory 2402 additionally stores a graphical representation 2422 and a project metrics data 2428. Graphical representation is a visual display of the overall organization of software design 2410. Project metrics data 2428 defines information associated with the development of software design (i.e. software design 2410). For example, project metrics data 2428 includes one or more of: start/end date, total number of requirements, expected requirement completion date, actual completion date, total number of processes, level of completion, any other information related to the software design development, and a combination thereof. As will be discussed in further detail below, project metrics data 2428, inter alia, is used to automatically assess developer effectiveness within the software development.

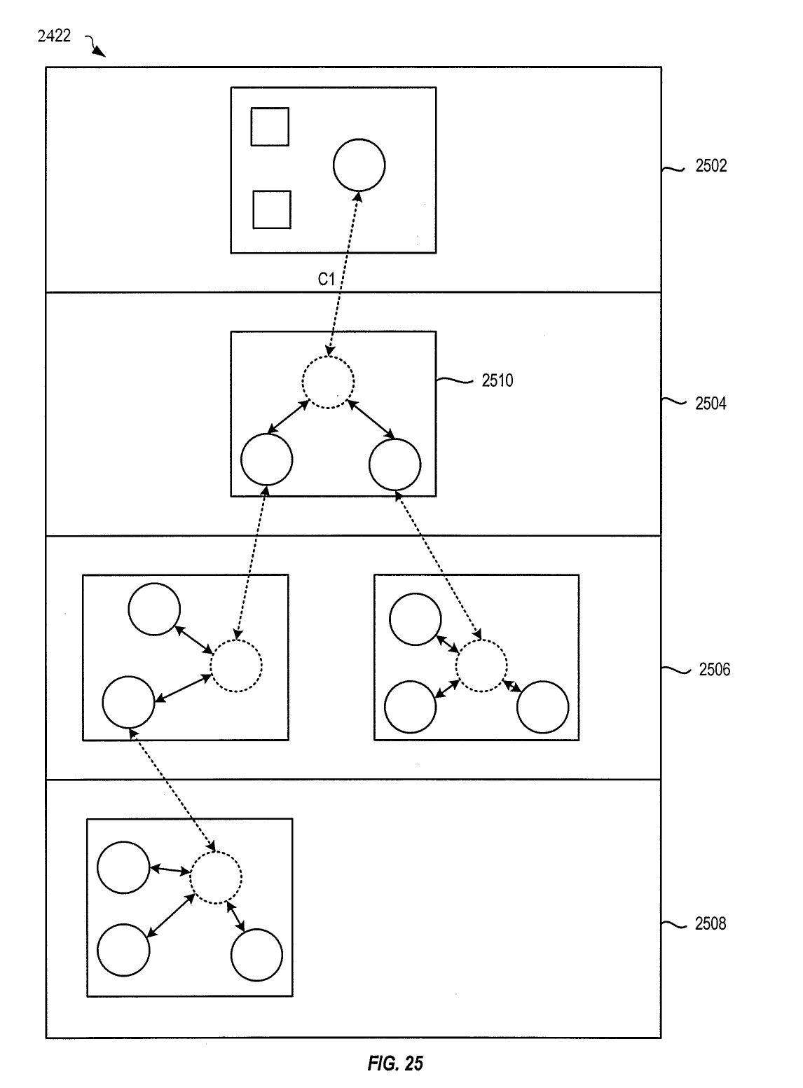

FIG. 25 depicts an exemplary graphical representation 2422 of software design 2410 of FIG. 24, in one embodiment. For example, graphical representation 2422 is stored within memory 2402. As illustrated in FIG. 25, dashed lines represent control flows, solid lines represent data flows, dashed circles (i.e. control bubbles) represent control transforms, solid circles (i.e. process bubbles) represent process transforms, and small squares represent terminators. Software design 2410 includes four design levels 2502, 2504, 2506 and 2508. More complex or simple software designs may be incorporated herein without departing from the scope hereof.

Software design 2410 is implemented as a decomposition diagram (i.e. illustrated in FIG. 25). The decomposition diagram includes the ability to find, test and associate code with all processes (i.e. solid circles). As will be discussed in further detail below, a developer (e.g. developer 2458) is assigned the various processes to complete and is considered to have a completed a process when there is an attached keywords 2412, attached description 2414, attached requirement 2416, attached test procedures 2418, and attached code 2420. It will be appreciated that more than one developer 2458 may be used to work on multiple processes either on the same decomposition level (e.g. level 2506) or on separate decomposition levels. Further, a developer can decompose a process that they are assigned into a lower decomposition level and is automatically assigned the work on the new decomposition level. An administrator (i.e. administrator 2448) can assign or un-assign developers to any process on any decomposition level.

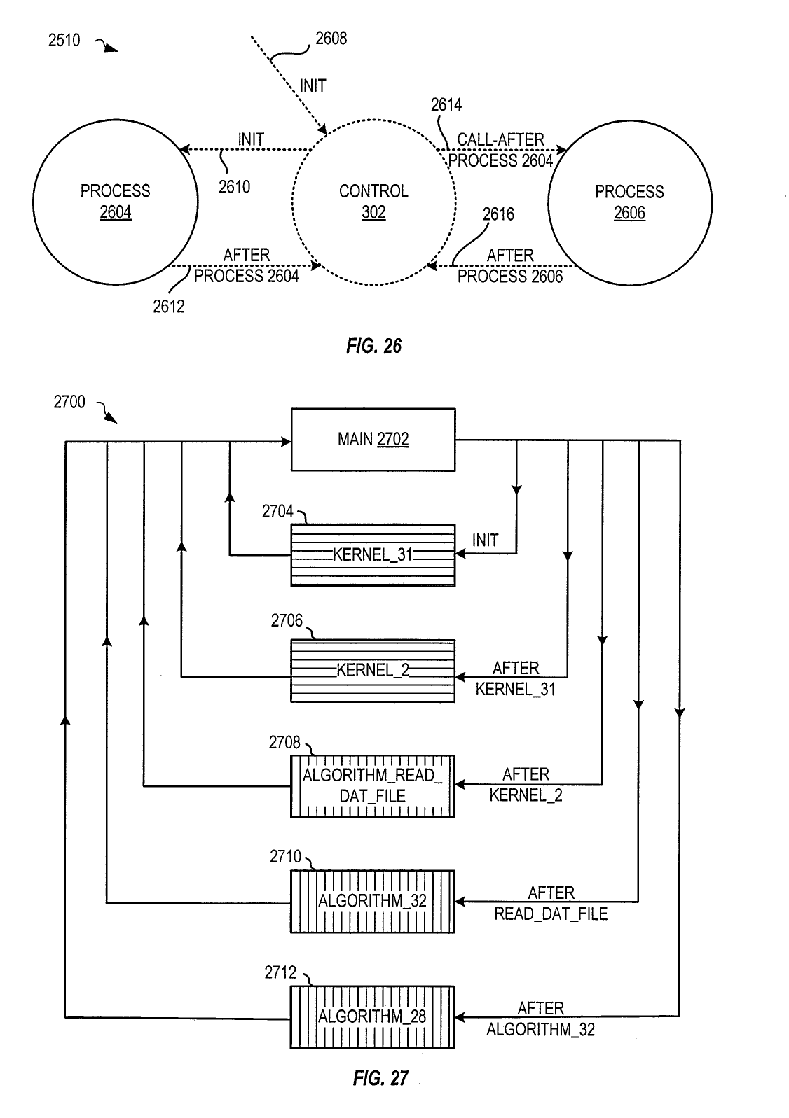

FIG. 26 depicts an exemplary software design process kernel 2510 having a plurality of control flows 2608-2614 within level 2504 of FIG. 25. If a process is equated to a task to be performed (i.e. by the software design) then each decomposition level could represent a group of linked tasks. Within a decomposition level, processes are always linked together using control flows attached to the central control transform. The purpose of a control flow is to specify when some process is to be called.

The control flows within FIG. 26 may contain three types of conditional statements: “init”, “if” and “call-after” or some combination of “if” and “call-after”. The “init” conditional statement (e.g. control flows 2608, 2610) represents the beginning of a series of processes. Note that the “init” condition is contained within control flow “C1” of FIG. 25. The first of a series of processes must have a start-by date and duration. If a control flow attached to a process does not contain either an “init” or a “call-after” conditional statement then it is considered the beginning of a series of processes. A series can be one or more processes linked together. The “call-after” conditional statement represents a sequence of activity: the current process is called after some other process has completed.

Accordingly, the process kernel 2510 would operate by control flow 2608 initializing control transformation 2602. Control transformation 2602 would then execute control flow 2610 to initialize process 2604. After process 2604 is executed, control flow 2612 executes to return to control transform 2602 which then executes control flow 2614 to execute process 2606. After process 2606, control flow 2616 executes to return to control transform 2602.

FIG. 27 depicts an exemplary graphical representation 2700 of a finite state machine of a software design, in one embodiment. For example, graphical representation 2700 is stored within memory as graphical representation 2422. The software design is typically displayed as a decomposition graph as discussed above with reference to FIGS. 25 and 26. The decomposition graph (i.e. graphical representation 2422 of FIG. 25) can be transformed into a finite state machine which shows only the control flows (as state transitions) and processes (as states). The transformation of the decomposition graph into a finite state machine is automatic. Thus, the creation of the graph automatically creates the finite state machine. As illustrated in FIG. 27, main 2702 having no fill represents the control process. The horizontal dashed fill (i.e. kernel_31 2704, and kernel_2 2706) represents non-decomposable processes (kernels). The vertical dashed fill (i.e. 2708-2712) processes represent decomposable processes (algorithms).

Referring back to FIG. 24, once a graphical representation of the software design has been developed administrator 2448, via administrator computer 2440 having an administrator interface 2446 including display 2442 and input device 2444, may allocate particular processes (i.e. process 2510) to a particular developer 2458. Developer 2458, via developer computer having a developer interface 2456 including a display 2452 and input device 2454, may then allocate one or more of the requirements, code, keywords, description and test procedures to the particular process.

### Automatic Developer Assessment Software Design Process:

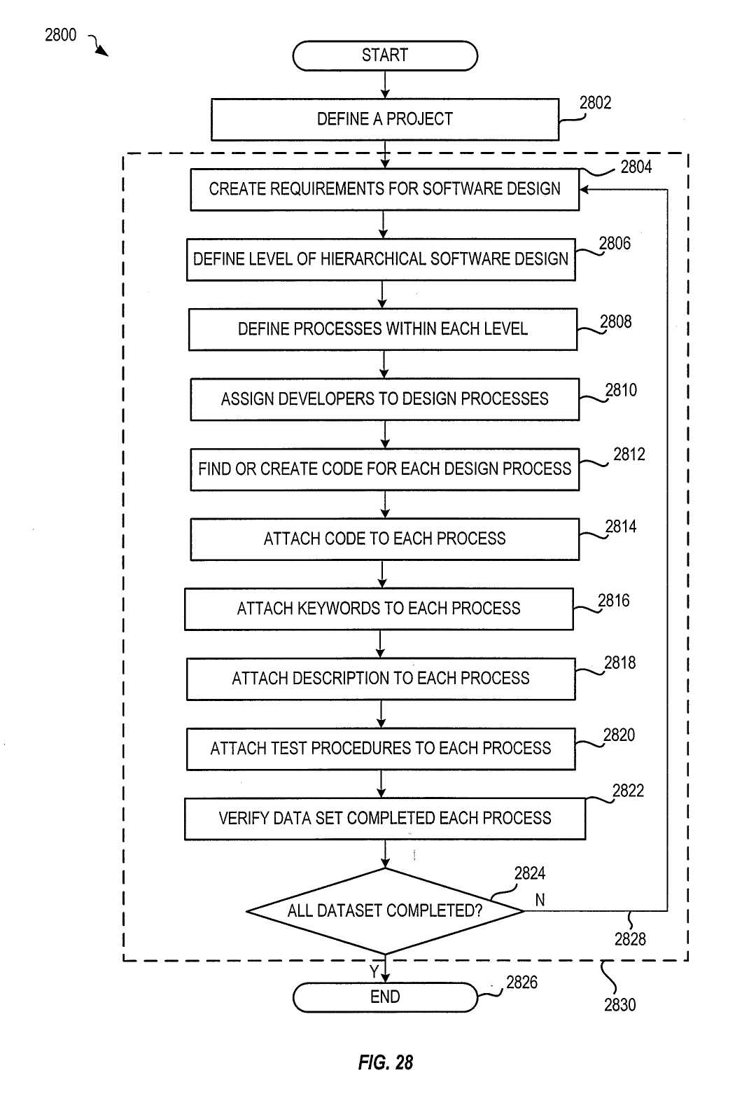

FIG. 28 depicts an exemplary software development method 2800 for generating a software design (e.g. software design 2410) within system 2400 of FIG. 24, in one embodiment. In general, method 2800 is an iterative method which starts with the definition of a project, continues with the creation of work requirements, creation of a software design model and/or graphical representation, assignment of design model elements (processes) to developers, creation/finding and attachment of developed code to the design model, and reconciliation of the work to the requirements. There are three roles in method 2800: solicitor (i.e. solicitor 2468), administrator (i.e. administrator 2448) and developer (i.e. developer 2458). Solicitor 2468 accesses system 2400, for example, to solicit a software design 2410. Solicitor may access system 2400 via a solicitor computer 2460 having a solicitor interface 2466 including a display 2462 and input device 2464. Typically an administrator defines/approves a project and creates the first iteration of the requirements. Sub-requirements are usually defined by a developer and approved by an administrator as the work progresses. A developer creates the model, writes the code and reconciles the code with both the model and requirements.

In step 2802, method 2800 defines a project. For example, a project is solicited within management server 2401 by solicitor 2468 via solicitor computer 2460. The project may be to design a software design, e.g. software design 2410. Further an administrator 2448 may be assigned to said project.

In step 2804, method 2800 receives the requirements for the software design. For example, administrator 2448, via administrator computer 2440, create each requirement 2416 associated with software design 2410. Processor 2406 then stores each requirement 2416 within dataset 2413 in association with software design 2410.

In step 2806, the each decomposition level of the software design is defined. For example, an administrator 148 defines each decomposition level 2504-2508 of the software design 2410. Processor 2406 then stores each description 2414 within dataset 2413 in association with software design 2410.

In step 2808, at least one process within each decomposition level, defined in step 2806, is defined. For example, administrator 2448 defines each process (i.e. process 2510) within decomposition level 2502-2508. Processor 2406 then stores each description within dataset 2413 in association with software design 2410.

In step 2810, at least one developer is assigned to each process defined in step 2808. For example, administrator 2448 assigns a developer 2458 to each process to be completed within software design 2410.

In step 2812, the developer assigned in step 2810 finds or creates code for each design process. In one embodiment, the developer 2458 writes a code 2420 to implement the assigned process.

In step 2814, the developer associates the code found or created in step 2812 to the process. For example, developer 2458 stores the code found/created in step 2812 within memory 2402 as code 2420 in dataset 2413 of software design 2410.

In step 2816, the developer associates at least one keyword to the process. For example, developer 2458 stores the keywords associated with process 2426 within memory 2402 as keywords 2412 in dataset 2413 of software design 2410.

In step 2818, the developer associates a description to the process. For example, developer 2458 stores the keywords associated with process 2426 within memory 2402 as keywords 2412 in dataset 2413 of software design 2410.

In step 2820, the developer associates test procedures to the process. For example, developer 2458 stores test procedures associated with process 2426 within memory 2402 as test procedures 2418 in dataset 2413 of software design 2410.

In step 2822, it is verified that all data set information is completed for each process. For example, administrator 2448 verifies that all information within dataset 2413, for each process 2426 within each decomposition design level 2424 is correctly completed.

Step 2824 is a decision. If, in step 2824, it is determined that all of dataset is completed (i.e. all of dataset 2413) for all processes, then method 2800 proceeds to end 2826. If, in step 2824, it is determined that all of dataset 2413 is not completed, method 2800 proceeds back to step 2804, along path 2828. This creates a loop structure, as illustrated by dashed line 2830. Loop 2830 repeats until all necessary dataset information is stored within memory. Loop 2830 may additionally operate to create additional decomposition design levels (i.e. design level 2424), and/or sub-processes within each design level (i.e. process 2426).

The steps of method 2800 may be performed using a developer assessor (i.e. developer assessor 2460) which is stored in memory 2402 as computer readable instructions that when executed by processor 2406 operates to interface development environment 2401 with one or more of solicitor, developer and administrator to perform the steps 2802-2824 of method 2800.

### Attaching Requirements to a Design:

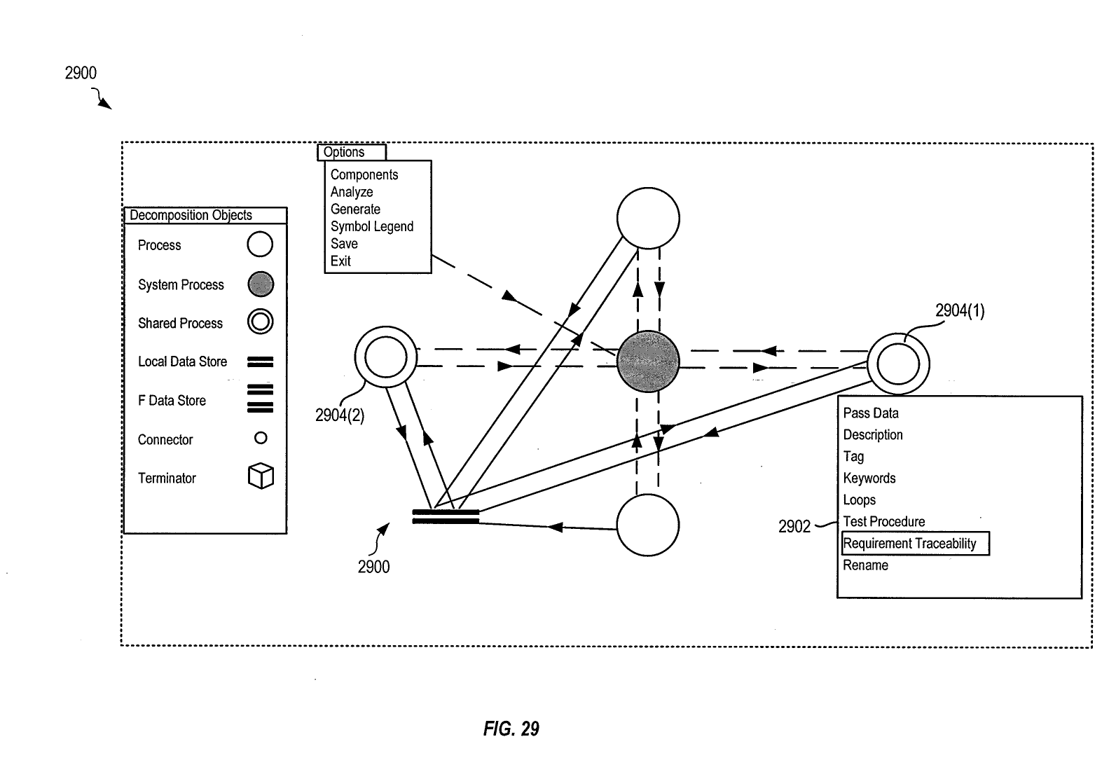

FIG. 29 depicts an exemplary screenshot 2900 including a drop down menu for associating a requirement with a process. For example, screenshot 2900 is displayed on one or more of administrator display 2442, developer display 2452, and solicitor display 2462. Screenshot 2900 includes graphical representation 2922 of the software design. Graphical representation 2922 is similar to graphical representation 2422 of FIG. 24. Screenshot 2900 further includes a drop down options menu 2902 that can be selected by one or more of administrator 2448, developer 2458 and solicitor 2468 to select a category to insert the requirement data with a particular process. There may be a separate drop down menu 2902 for each process 2904. For example, drop down menu 2902 is used to implement step 2804 of method 2800.

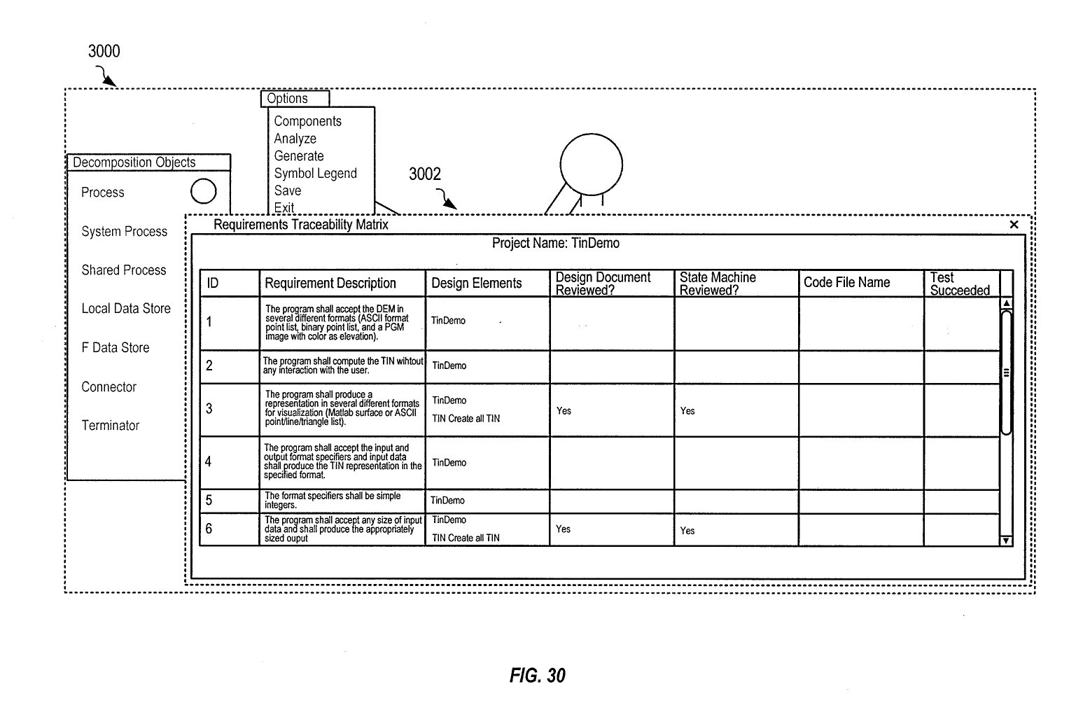

FIG. 30 depicts an exemplary requirements matrix 3002 showing associated requirements to each process within screenshot 3000, in one embodiment. Requirements matrix 3002 may be accessed via a drop down menu within screenshot 2900 of FIG. 29, for example. Requirements matrix 3002 allows for one or more of developer 2458, administrator 2448 and solicitor 2468 to trace when and what requirements are associated with each process (e.g. process 2904(1), 2904(2). Further, Requirement matrix 3002 allows tracking of which processes need to be completed still.

After processes are attached to particular requirements, for example after step 2808, information about each process and associated requirement can be tracked within project metrics data.

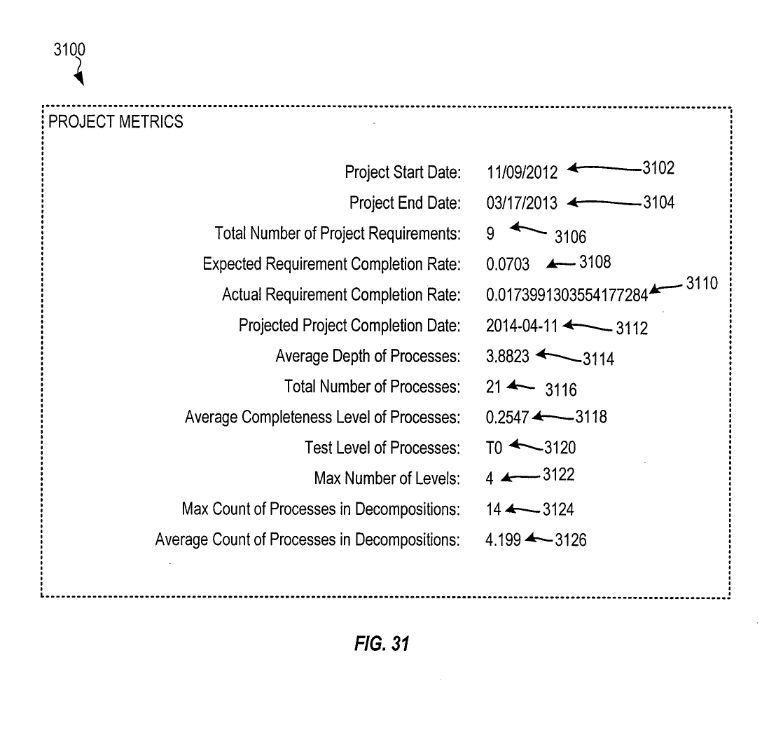

FIG. 31 depicts an exemplary screenshot 3100 of a project metrics data. Screenshot 3100 may be accessed via any computer (e.g. computer 2440, 2450, and/or 2460). A “Project Start Date” 3102 and a “Project End Date” 3104 are entered by the administrator. A “Total Number of Requirements” 3106 defines the total number of requirements to be met within an overall software design (e.g. software design 2410). A “Expected Requirement Completion Rate” 3108 is automatically computed from the number of requirements divided by the number of project days (Project End Date—Project Start Date). A “Actual Requirement Completion Rate” 3110 is automatically computed, using processor 2406 for example, from the number of requirements completed divided by the number of days past the project start date. The number of requirements left to complete multiplied by the “Actual Requirement Completion Rate” gives the number of days needed to finish the requirements; this number is then added to the current date to give a “Projected Project Completion Date” 3112. An “Average Depth of Processes” 3114 is the average number of decomposition levels for each initial process. A “Total Number of Processes” 3116 is a count of all processes in a project. An “Average Completeness Level of Processes” 3118 is the average number of embedded symbols completed per process. A “Test Level of Processes” 3120 is, for example, T0 if there is at least one process without a test procedure, T1 if all processes have a single test procedure, or T2 if each state transition (control flow) attached to each process has at least one test procedure. Other identifications may be used without departing from the scope hereof. A “Max Number of Levels” 3122 is the count of the decomposition levels of the process with the most decomposition levels. An “Average Count of Processes in Decomposition” 3126 is the average of number of processes into which any initial process decomposes.

Information 3102-3126 may be stored within memory 2402 as project metrics data 2428.

### Attaching Dataset Information to a Software Design

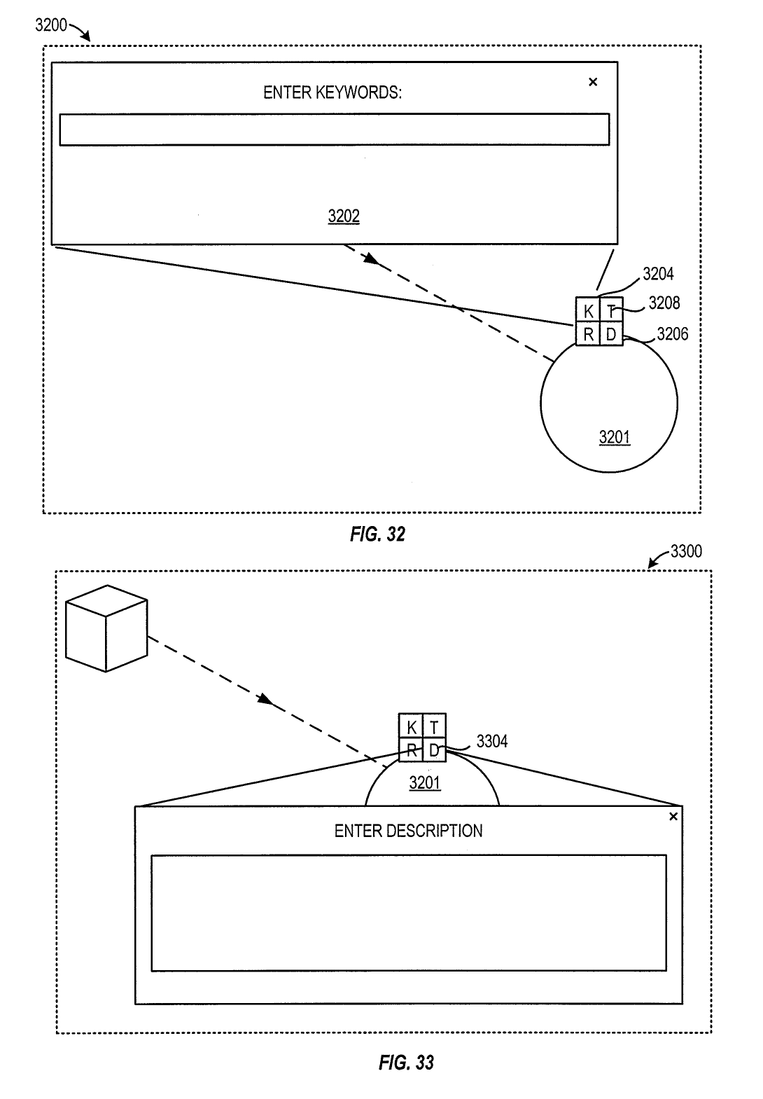

FIG. 32 depicts a screenshot 3200 of an exemplary popup window 3202 for attaching keywords to a process 3201 of software design. Process 3201 includes an associated button set 3206 including keyword button 3204. When a user, e.g. developer 2458, selects keyword button 3204 a keyword popup window 3202 appears. The user may then input the keywords associated with process 3201. The input keywords are then stored as keywords 2412 within memory 2402.

FIG. 33 depicts a screenshot 3300 of an exemplary popup window 3302 for attaching a description to process 3201 of FIG. 32. When description button 3304 is selected by a user, description popup window 3302 appears. The user may then input the description associated with process 3201. The input description is then stored for example as description 2414 within memory 2402.

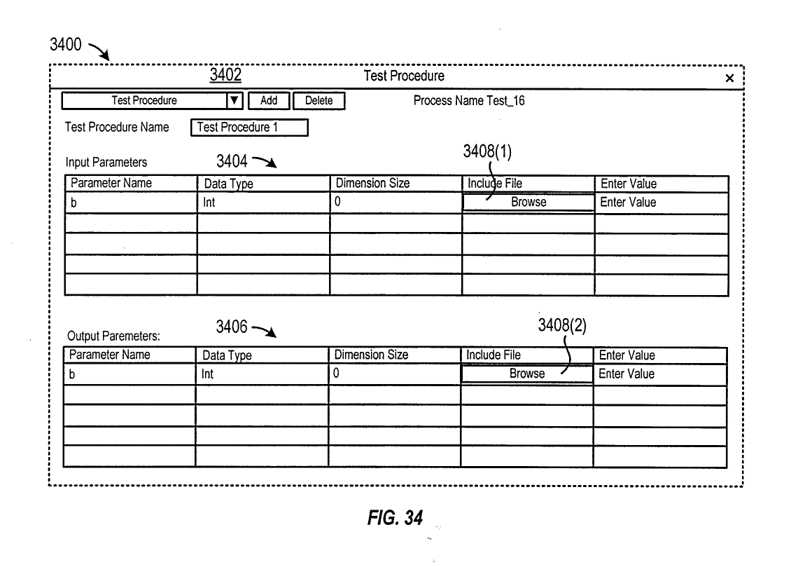

FIG. 34 depicts a screenshot 3400 of an exemplary popup window 3402 for attaching at least one test procedure to process 3201 of FIG. 32. Screenshot 3400 includes test procedure popup window 3402. Popup window 3402 appears for example when test procedure button 3208 is selected by a user. Test Procedure popup window 3402 allows a user to define input parameters 3404 and output parameters 3406. Further, a test procedure file may be included by selecting the “browse” buttons 3408(1), 3408(2). Accordingly, a test procedure file may be linked to each input and output parameters 3404, 3406, respectively, such that when the file is executed, using processor 2406 for example, it is determined if the process will function properly within the software design. Once popup window 3402 is completely filled in by the user, the test procedures including input parameters 3404, output parameters 3406 and any associated test procedure files 3408(1) and 3408(2) are then stored for example as test procedures 2418 within memory 2402.

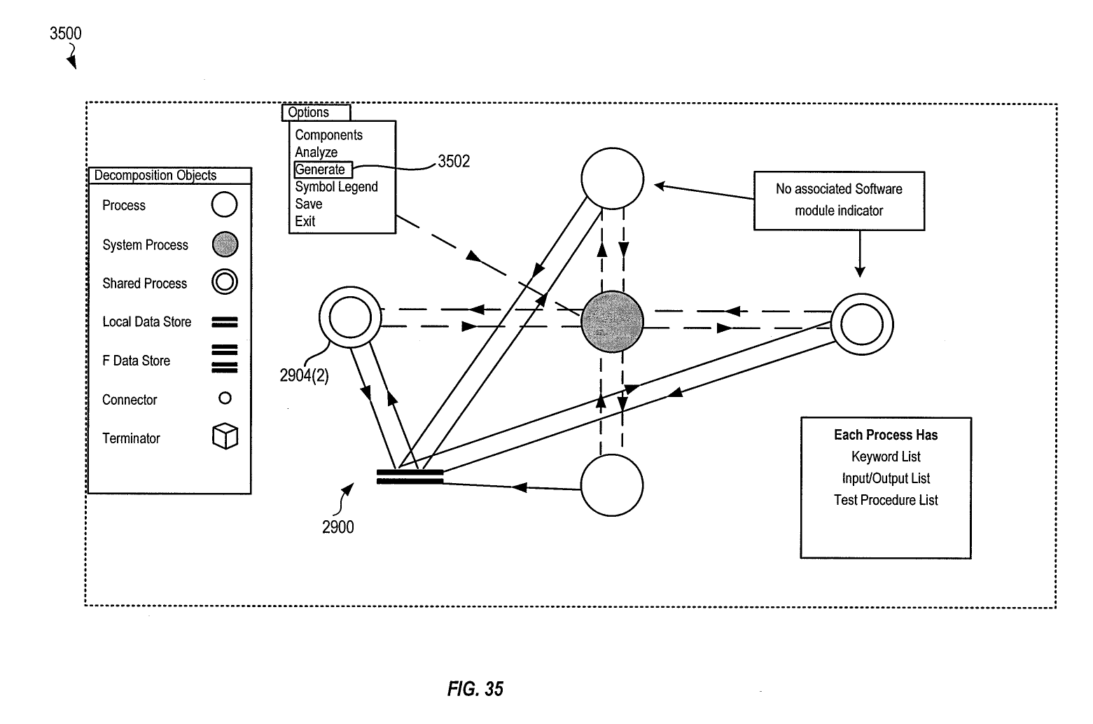

FIG. 35 depicts a screenshot 3500 of an exemplary popup window including a “generate” button 3502 for attaching code to particular processes. For example, when selected, the generate button 3502 may attach code to all processes within the entire software design, a particular decomposition level, or only a single process. In one embodiment, once generate button 3502 is selected, the user may specifically select particular code to be associated with each process. In an alternate embodiment, once generate button 3502 is selected code for each process is automatically located within a code database 2430 of management server 2401. Once code is generated for each particular process, the code is stored within memory 2402 as code 2420, for example.

### Administrator Ranking of Developers

Once a developer has completed association of the code, keywords, description, requirements, and test procedures to a process that the developer is assigned to, an administrator acceptance and developer ranking process may begin.

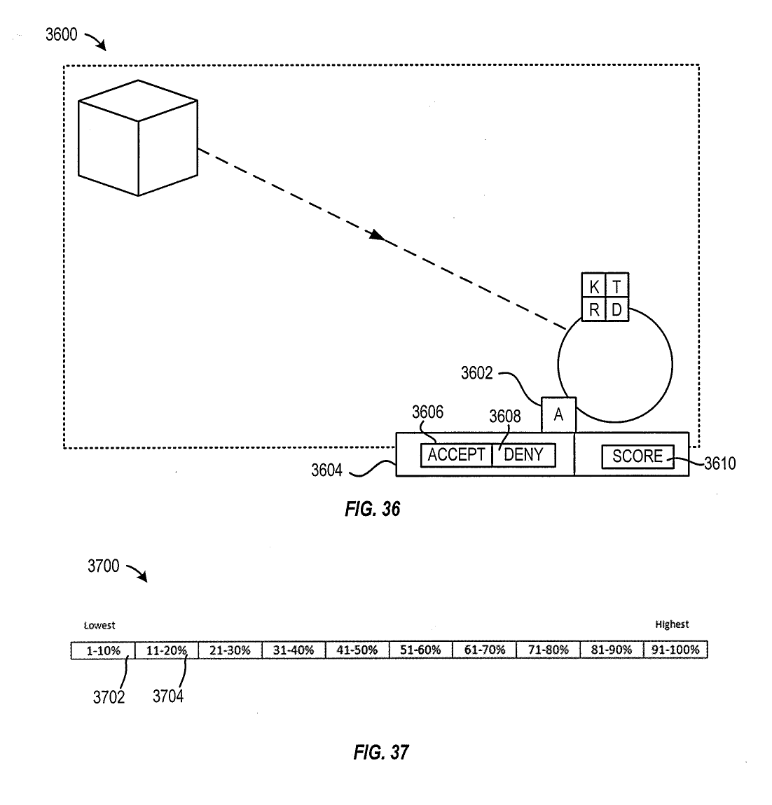

FIG. 36 depicts an exemplary screenshot 3600 including an administrator acceptance button 3602. Once acceptance button 3602 is selected by an administrator, e.g. administrator 2448, acceptance popup window 3604 appears. A process is accepted when all activities associated with that process are completed and the accept button has been selected by the administrator. In one embodiment, the administrator acceptance button 3602 is not available to select until all of dataset (e.g. dataset 2413) has been completed by a developer. Selecting the “accept” button 3606 within popup window 3604 causes the process to be accepted with the date of acceptance logged, for example within project metrics 2428. Selecting the deny button 3608 causes the denied count to be incremented within project metrics 2428. Selecting the score button 3601 within popup window 3604 allows the administrator to input a score that defines the administrator's impression of how well the developer completed the assigned process.

In one embodiment, a score is a number from one to ten given by the administrator. Since it is impossible to know how a particular administrator selects a score, the raw score can be misleading. However, given a particular project, the scores for each developer can be compared and converted into a ranking FIG. 37 depicts an exemplary ranking array 3700 for ranking developers over a single project. For example, if all scores are placed in array 3700 having ten elements, the largest number first, with the first element 3702 containing the project scores of the lowest ten percent of developer scores, the second element 3704 containing the next eleven percent through twenty percent, and so on. Accordingly, the scores are ranked relative to each developer within a single project. Both the score and ranking may then be stored within memory 2402 as developer statistics 2432 and used to compare the developer against other developers.

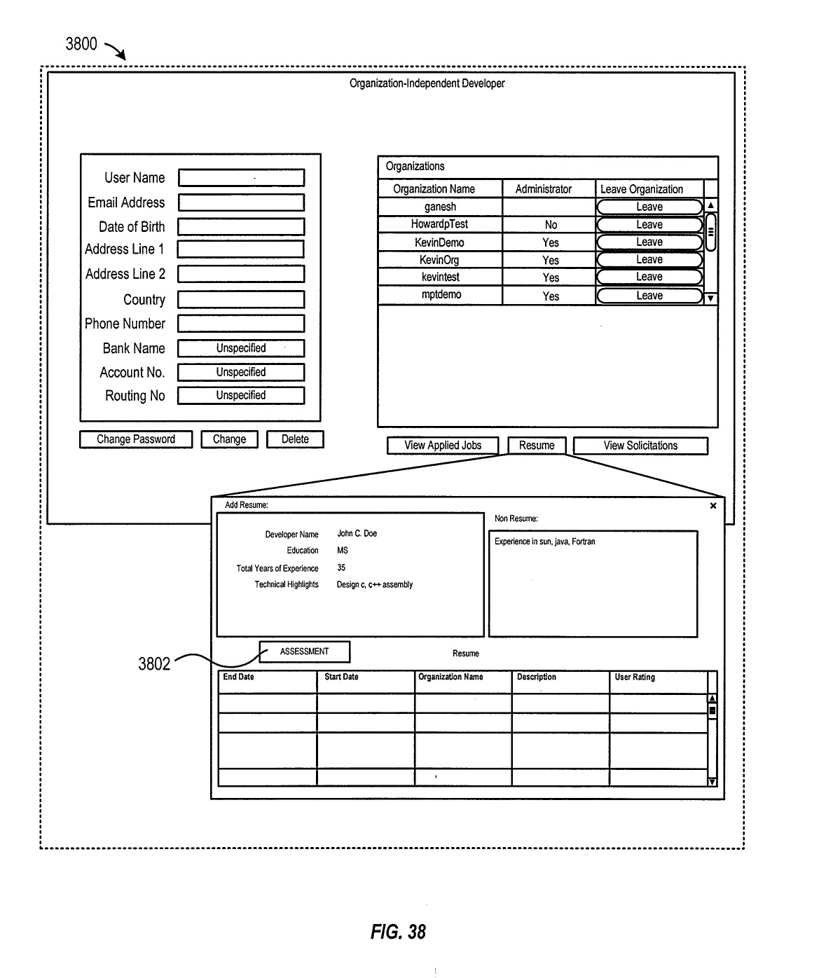

FIG. 38 depicts an exemplary screenshot 3800 including a developer résumé 130 created within system 101 of FIG. 1. For example, developer résumé 130 is displayed on any authenticated computer coupled to management server 2401. When a process has been accepted by the administrator and each developer scored by the administrator, for example according to FIGS. 32-37, the following assessment information may be tracked and stored within developer statistics 2432 within a database or memory 2402. Assessment information can include any one of the following:
Average Administrator Ranking—Defining the average ranking per process per skill per project;
Average Group Size—Defining the average number of developers per project;
Total Experience—Defining the total experience gained per project per skill;
Completion Rank—Defining the average process completion rank;
Completion Rank for Skills—Defining the average completion rank per skill;
Acceptance Rank—Defining the average ranking of number of attempts before submission accepted (fewer attempts is better);
Average Project Size Processes—Defining the average number of processes per project;
Average Project Size Requirements—Defining the average number of requirements per project;
Average Project Size Time—Defining the average total project duration;
Average Earnings Per Skill—Defining the average earnings per skill;
Average Earnings Ranking Per Skill—Defining the earnings ranking per skill; and
Any combination thereof.

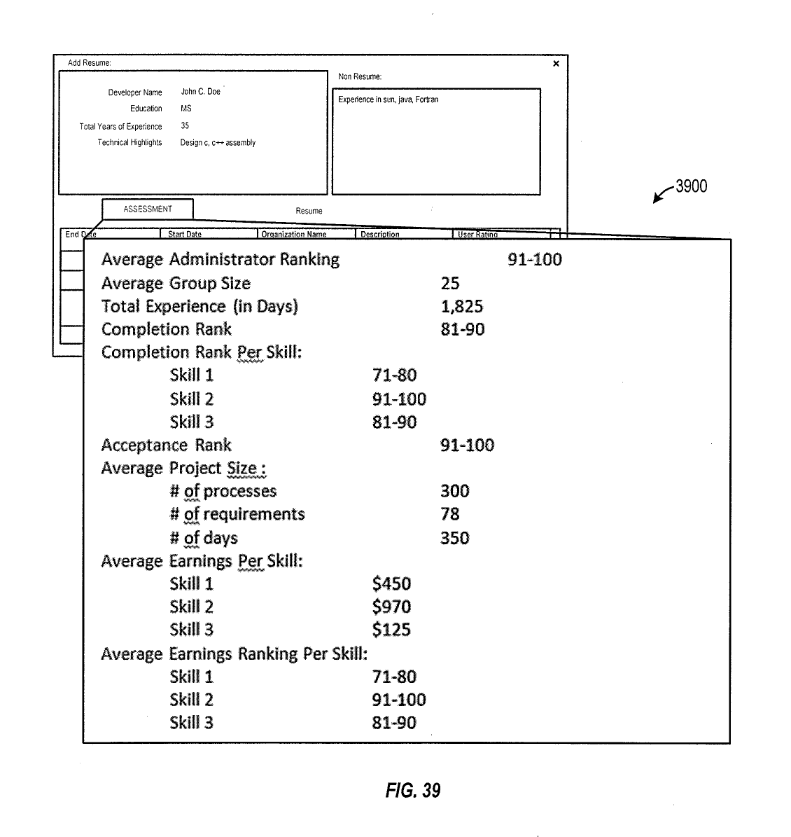

At least one of the above assessment information is included in assessment display box 3802. Alternatively, assessment display box 3802 may be a button wherein it pops up a window 3900 displaying additional assessment information as illustrated in FIG. 39.

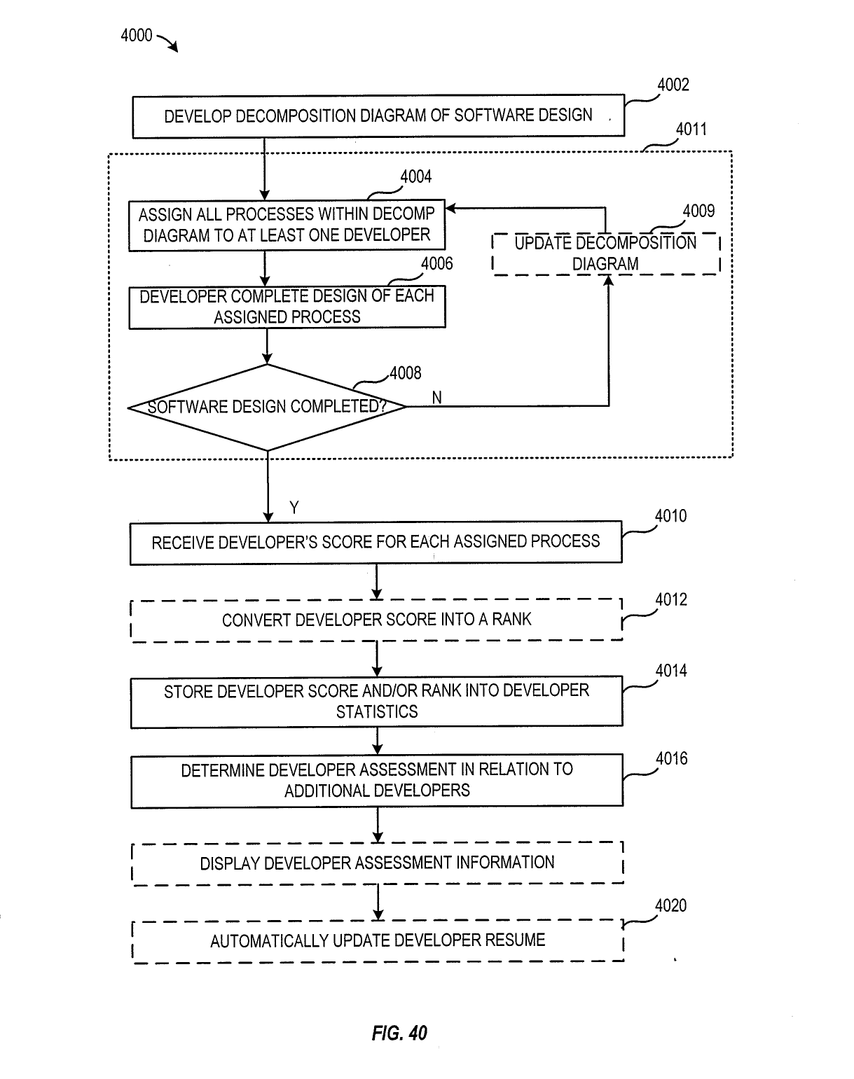

FIG. 40 depicts an exemplary method 4000 for automatic developer assessment, in one embodiment.

In step 4002, a decomposition diagram of a particular software design is developed. For example, one or more of administrator 2448 and developer 2458 obtain a solicitation to produce software design 2410 from solicitor 2468. One or more of administrator 2448 and developer 2458 then develops a hierarchical decomposition diagram including each decomposition level and each particular process within each decomposition level. A graphical representation 2422 of the decomposition diagram may be additionally stored within memory 2402 via processor 2406.

In step 4004, at least one developer is assigned to each process within the decomposition diagram. Administrator 2448 may assign one or more developers 2458 to each process within the decomposition diagram. Alternatively, developer assessor 2460, via processor 2406, may automatically assign a developer to each process, or any other element of the software design 2410, within the decomposition diagram.

In step 4006, the developer completes the design of each assigned process from step 4004. Developer 2458 may complete steps 2812-2820 of method 2800 to complete design of each assigned process.

Step 4008 is a decision. In one embodiment of step 4008, administrator 2448 determines whether dataset 2413 is completed for all processes within software design 2410. In an alternate embodiment of step 4008, processor 2406 verifies that dataset 2413 is completed for all processes 2426 within software design 2410. If it is determined that software design 2410 is complete, method 4000 proceeds with step 4010. If it is determined that software design is incomplete, method 4000 proceeds with step 4009.

In optional step 4009, the decomposition diagram is updated. For example one or more of developer 2458 and administrator 2448 update the decomposition design diagram by adding one or more decomposition levels or one or more processes within one or more decomposition levels. Upon updating the decomposition diagram, method 4000 proceeds with step 4004, thereby creating a loop 4011 until software design (i.e. software design 2410) is completed.

In step 4010, the developer's score for each assigned process is received. For example, administrator 2448 assigns a score defining the how well the developer completed the process for each process 2426.

In optional step 4012, each developer score into a rank. For example, processor 2406 converts developer score, stored within developer statistics 2432, into a rank based upon a ranking array, as discussed in FIGS. 36-37.

In step 4014, the developer's score and/or rank, determined in steps 4012 and 4014, respectively, is stored within the developer's statistics. For example, processor 2406 stores the score and/or rank within developer statistics 2432.

In step 4016, the developer's assessment in relation to additional developers is determined. For example, processor 2406 computes additional developer statistics such as assessment information discussed above, and compares the developer assessment information to other developers, associated with management server 2401 and additionally stores developer assessment information within developer statistics 2432.

In optional step 4018, the developer's assessment information is displayed. For example, the developer assessment information is displayed on one or more of developer computer 2450, administrator computer 2440 and solicitor computer 2460.

In optional step 4020, the developer résumé is automatically updated. For example, the developer résumé 2434 is automatically updated with developer statistics 2432. In another example, the developer résumé 2434 is updated consistent with the concepts discussed within U.S. Provisional Application Ser. No. 61/776,484, filed Mar. 11, 2013, entitled “System for Automatic Skills Tracking and Job Payment Determination and Associated Methods”, and incorporated herein by reference.

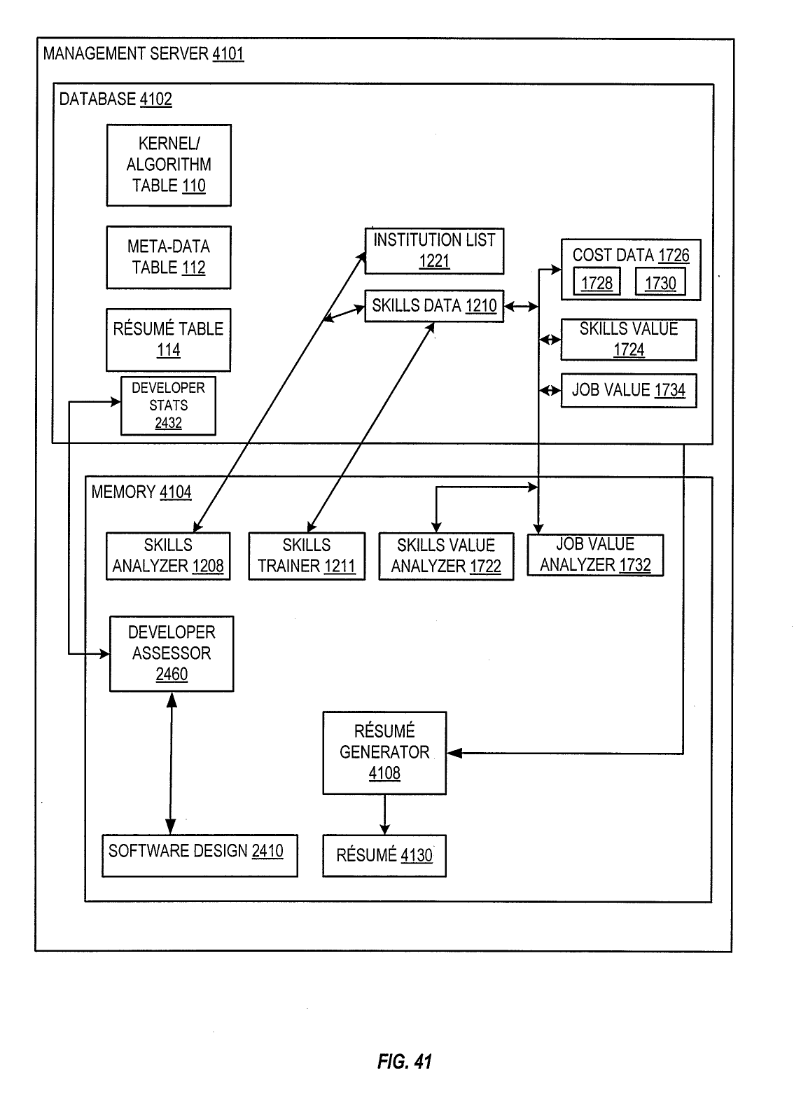

FIG. 41 depicts an exemplary management server 4101 for generating a developer résumé 4130 utilizing one or more of the above described concepts, in one embodiment. For example, management server 4101 is a detailed view incorporating elements from one or more of management servers 101, 1201, 1701, and 2401. Management server 4101 includes database 4102 and memory 4104. Memory 4104 incorporates modules described above for generating and populating résumé 4130 with information. For example, skills analyzer 1208, skills trainer 1211, skills value analyzer 1722, job value analyzer 1732, and developer assessor 2460 may operate to develop and manage information stored within database 4102.

Database 4102 may include institution list 1221 and skills data 1210 which each are populated by one or more of skills analyzer 1208 and skills trainer 1211 as discussed above. Database 4102 may further include cost data 1726 and associated development fee 1728 and license fee 1730, skills value 1724 and job value 1734 as populated by one or more of skills value analyzer 1722 and job value analyzer 1732 as described above. Database 4102 may further include developer stats 2432 as populated by developer assessor 2460 as discussed above. Kernel algorithm table 110, meta-data table 112 and résumé table 114 may all be populated in a manner as discussed with reference to FIGS. 1-11.

Résumé generator 4108 may then utilize any information stored within database 4102 to generate résumé 4130.

Accordingly, it will be understood that any of the above described features are interchangeable within any of development systems 100, 1200, 1700, and 2400.

Combination of Features:

Features described above as well as those claimed below may be combined in various ways without departing from the scope hereof. The following examples illustrate some possible combinations:

(A) A method for automatically generating a résumé of a developer using a development environment, the method including: retrieving, from a database and using a processor of the development environment, information including work completed by the developer and associated start and end dates of the completed work.

(B) In the method denoted as (A), the method further including generating, using the processor, a description of developer experience within the development environment based upon the completed work and the associated start and end dates.

(C) In the methods denoted as either (A) or (B), wherein a first date when the developer is given edit privileges to the completed work within the development environment defines the associated start date.

(D) In any of the methods denoted as either (A) through (C), wherein a second date when an administrator of the development environment submits that the work is completed defines the associated end date.

(E) In any of the methods denoted as (A) through (D), the method further including receiving a skill pass notification defining a developer skill from a training institution.

(F) In the method denoted as (E), the method further including adding the developer skill to the résumé.

(G) In the methods denoted as either (E) or (F), the method further including determining whether the training institution is trusted based upon an institution list within the database.

(H) In any of the methods denoted as (E) through (G), the method further including adding a certified indication to the résumé in association with the developer skill when the training institution is trusted.

(I) In any of the methods denoted as (A) through (H), the method further including receiving a developer skill training request from the developer.

(J) In the method denoted as (I), the method further including providing a training program associated with the developer skill to the developer.

(K) In the method denoted as (J), the method further including adding the developer skill to the résumé if the developer completes the training program above a threshold of acceptability.

(L) In any of the methods denoted as (A) through (K), the method further including determining a developer fee associated with a developer skill of the developer.

(M) In any of the methods denoted as (A) through (L), the method further including determining a license fee associated with the developer skill.

(N) In either of the methods denoted as (L) or (M), the method further including adding one or both of the license fee and the developer fee in association with the developer skill on the résumé.

(O) In any of the methods denoted as (A) through (N), the method further including receiving a developer assessment score for the completed work from an administrator of the development environment.

(P) In the method denoted as (O), the method further including adding the developer assessment score to the résumé in association with the completed work.

(Q) In either method denoted as (O) and (P), the method further including wherein the developer assessment score is based upon a ranking of the developer against other developers who also worked on the completed work.

(R) A method for automatically determining the value of a developer skill within a development environment including receiving, from a value requestor, a skills input defining a developer skill to be valued.

(S) The method denoted as (R), the method further including determining, using a skill value analyzer of the development environment, a developer fee associated with the developer skill.

(T) In either method denoted as (R) and (S), the method further including determining, using the skill value analyzer of the development environment, a license fee associated with the developer skill.

(U) In any of the methods denoted as (S) and (T), the method further including displaying one or more of the license fee and developer fee to the value requestor.

(V) In any of the methods denoted as (T) through (U), the method further including automatically determining, using a job value analyzer, an associated cost for a job using the developer skill based on one or more of the average developer fee, the average license fee, an average completion time required for jobs using the developer skill, and the average number of administrators required for jobs completed using the developer skill; and displaying the associated cost to the value requestor.

(W) A method for automatic developer assessment of a developer within a development server, the method including receiving a decomposition diagram of a software design including a plurality of decomposition levels each having at least one process.

(X) In the method denoted as (W), the method further including assigning at least one first developer to each at least one process.

(Y) In the method denoted as either (W) or (X), the method further including determining whether the software design is complete.

(Z) In any of the methods denoted as (W) through (Y), the method further including assigning a score to the at least one first developer for each at least one process.

(AA) In the method denoted as (Z), the step of assigning a score including receiving a first score from an administrator of the development server; and, converting, using a processor, the first score into a rank based upon at least one second score for other developers working on the software design.

(BB) In any of the methods denoted as (W) through (AA), the method further including determining developer assessment information as compared to at least one second developer.

(CC) In the method denoted as (BB), the method further including displaying the developer assessment information on a display.

(DD) In any of the methods denoted as (W) through (CC), the method further including automatically updating a résumé of the developer within the development server.

(EE) A system for automatically generating a résumé of a developer using a development environment, including: a résumé generator, stored within memory as computer readable instructions that when executed by a processor perform the functions of: retrieving, from a database, information including work completed by the developer and associated start and end dates of the completed work, and generating the résumé including a description of developer experience within the development environment based upon the completed work and the associated start and end dates.

(FF) The system denoted as (EE), wherein a first date when the developer is given edit privileges to the completed work within the development environment defines the associated start date.

(GG) In either system denoted above as (EE) and (FF), wherein a second date when an administrator of the development environment submits that the work is completed defines the associated end date.

(HH) In any of the systems denoted above as (EE) through (HH), the system further including a skills analyzer, stored on the memory as computer readable instructions that when executed by the processor perform the functions of receiving a skill pass notification defining a developer skill from a training institution, and determining whether the training institution is trusted based upon an institution list within the database.

(II) In the system denoted above as (HH), wherein the résumé generator adds the developer skill to the résumé.

(JJ) In either system denoted above as (HH) and (II), wherein the résumé generator adds a certification indication to the résumé in association with the developer skill when the training institution is trusted.

(KK) In any of the systems denoted above as (EE) through (JJ), the system further including a skills trainer, stored on the memory as computer readable instructions that when executed by the processor perform the functions of receiving a developer skill training request from the developer, providing a training program associated with the developer skill to the developer, and determining if the developer completes the training program above a threshold of acceptability.

(LL) In the system denoted above as (KK), wherein the résumé generator adds the developer skill if the developer completes the training program above a threshold of acceptability.

(MM) In any of the systems denoted above as (EE) through (LL), the system further including a developer assessor, stored on the memory as computer readable instructions that when executed by the processor perform the function of receiving a developer assessment score for the completed work from an administrator of the development environment.

(NN) In the system denoted above as (MM), wherein the résumé generator adds the developer assessment score to the résumé in association with the completed work.

(OO) In either system denoted above as (MM) and (NN), wherein the developer assessment score is based upon a ranking of the developer against other developers who also worked on the completed work.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for automatically generating a résumé of a developer using a development environment, comprising:
retrieving, from a database and using a processor of the development environment, information including work completed by the developer, and associated start and end dates of the completed work; and
generating, using the processor, a description of developer experience within the development environment based upon the completed work and the associated start and end dates.

2. The method of claim 1, wherein a first date when the developer is given edit privileges to the completed work within the development environment defines the associated start date.

3. The method of claim 5, wherein a second date when an administrator of the development environment submits that the work is completed defines the associated end date.

4. The method of claim 1, further comprising:
(a) receiving a skill pass notification defining a developer skill from a training institution;
(b) adding the developer skill to the résumé;
(c) determining whether the training institution is trusted based upon an institution list within the database; and
(d) adding a certified indication to the résumé in association with the developer skill when the training institution is trusted.

5. The method of claim 1, further comprising:
(a) receiving a developer skill training request from the developer;
(b) providing a training program associated with the developer skill to the developer;
(c) adding the developer skill to the résumé if the developer completes the training program above a threshold of acceptability.

6. The method of claim 1, further comprising:
(a) determining a developer fee associated with a developer skill of the developer;
(b) determining a license fee associated with the developer skill; and
(c) adding one or both of the license fee and the developer fee in association with the developer skill on the résumé.

7. The method of claim 1, further comprising:
(a) receiving a developer assessment score for the completed work from an administrator of the development environment;
(b) adding the developer assessment score to the résumé in association with the completed work.

8. The method of claim 12, wherein the developer assessment score is based upon a ranking of the developer against other developers who also worked on the completed work.

9. A method for automatically determining the value of a developer skill within a development environment comprising:
(i) receiving, from a value requestor, a skills input defining a developer skill to be valued;
(ii) determining, using a skill value analyzer of the development environment, a developer fee associated with the developer skill;
(iii) determining, using the skill value analyzer of the development environment, a license fee associated with the developer skill; and,
(iv) displaying one or more of the license fee and developer fee to the value requestor.

10. The method of claim 9, further comprising automatically determining, using a job value analyzer, an associated cost for a job using the developer skill based on one or more of the average developer fee, the average license fee, an average completion time required for jobs using the developer skill, and the average number of administrators required for jobs completed using the developer skill; and displaying the associated cost to the value requestor.

11. A method for automatic developer assessment of a developer within a development server, the method comprising:
receiving a decomposition diagram of a software design including a plurality of decomposition levels each having at least one process;
assigning at least one first developer to each at least one process;
determining whether the software design is complete;
assigning a score to the at least one first developer for each at least one process; and,
determining developer assessment information as compared to at least one second developer.

12. The method of claim 18, the step of assigning a score including:
receiving a first score from an administrator of the development server; and,
converting, using a processor, the first score into a rank based upon at least one second score for other developers working on the software design.

13. The method of claim 18, further comprising displaying the developer assessment information on a display.

14. The method of claim 18, further comprising automatically updating a résumé of the developer within the development server.

15. A system for automatically generating a résumé of a developer using a development environment, comprising:
a résumé generator, stored within memory as computer readable instructions that when executed by a processor perform the functions of:
retrieving, from a database, information including work completed by the developer and associated start and end dates of the completed work, and
generating the résumé including a description of developer experience within the development environment based upon the completed work and the associated start and end dates.

16. The system of claim 15, wherein
a first date when the developer is given edit privileges to the completed work within the development environment defines the associated start date, and
a second date when an administrator of the development environment submits that the work is completed defines the associated end date.

17. The system of claim 15, further comprising:
a skills analyzer, stored on the memory as computer readable instructions that when executed by the processor perforin the functions of
receiving a skill pass notification defining a developer skill from a training institution, and
determining whether the training institution is trusted based upon an institution list within the database;
wherein the résumé generator adds the developer skill to the résumé, and the résumé generator adds a certification indication to the résumé in association with the developer skill when the training institution is trusted.

18. The system of claim 15, further comprising:
a skills trainer, stored on the memory as computer readable instructions that when executed by the processor perform the functions of
receiving a developer skill training request from the developer,
providing a training program associated with the developer skill to the developer, and
determining if the developer completes the training program above a threshold of acceptability;
wherein the résumé generator adds the developer skill if the developer completes the training program above a threshold of acceptability.

19. The system of claim 15, further comprising:
a skill value analyzer, stored on the memory as computer readable instructions that when executed by the processor perform at least one of the functions of
determining a developer fee associated with a developer skill of the developer, and
determining a license fee associated with the developer skill;
wherein the résumé generator adds one or more of the developer fee and license fee to the résumé.

20. The system of claim 15, further comprising:
a developer assessor, stored on the memory as computer readable instructions that when executed by the processor perform the function of receiving a developer assessment score for the completed work from an administrator of the development environment;
wherein the résumé generator adds the developer assessment score to the résumé in association with the completed work.

21. The system of claim 20, wherein the developer assessment score is based upon a ranking of the developer against other developers who also worked on the completed work.
